(19) United States
(12) Patent Application Publication
(10) Pub. No.: US 2008/0098088 A1
(43) Pub. Date: Apr. 24, 2008

(54) Communication System, Terminal Device And Communication Device

(76) Inventors: Hirokazu Tamano, Osaka (JP); Hideaki Takechi, Osaka (JP); Tadashi Kunihira, Osaka (JP); Monta Nakatsuka, Osaka (JP)

Correspondence Address: WENDEROTH, LIND & PONACK L.L.P., 2033 K. STREET, NW, SUITE 800, WASHINGTON, DC, 20006, US

(21) Appl. No.: 11/795,118

(22) PCT Filed: Jan. 11, 2006
(86) PCT No.: PCT/JP06/00211

§ 371 Date: Jul. 12, 2007

(30) Foreign Application Priority Data
Jan. 13, 2005 (JP) 2005-006505

(51) Int. Cl. H04L 12/46

(52) U.S. Cl. 709/218

(57) ABSTRACT

A communication system including: a terminal (121); and a device (111), a device (112), and a device (113) existing within a LAN (110) connected to the terminal (121) through the Internet. The terminal (121) includes: a representative device preference storing unit (14) that stores information about processing performed by plural devices; a terminal control unit (15) that determines a representative device serving as a representative from among a plural devices based on information stored in the representative device preference storing unit (14); and a terminal side communication unit (10) that transmits a request for information about the devices within the LAN (110) to the representative device and receives a response to the request from the representative device. The device (111) includes: a device side communication unit (1) that receives a request for the information about the devices within the LAN from the terminal (121); and a device control unit (6) that acquires the information about the devices within the LAN (110) from the devices within the LAN (110). When receiving the request from the terminal (121), the device side communication unit (1) further transmits, as a response, the information acquired by the device control unit (6) to the terminal (121).

### TECHNICAL FIELD

The present invention relates to a communication system, a terminal device, and communication devices in which the terminal connected to the Internet and the communication devices within a LAN perform communication with each other.

### BACKGROUND ART

When communication is performed between devices connected to the Internet, a global IP address uniquely assigned to each device is used. However, with the recent increase in the number of devices connected to the Internet, a shortage of global IP addresses has been perceived as a problem. As a typical method to handle this problem, a method has been proposed in which private IP addresses that are unique only within the same LAN defined by RFC1918 are assigned, to the devices belonging to a home or office local area network (hereinafter, referred to as “LAN”), and when connection to the Internet is established from the LAN, a router is used that has a network address translation (hereinafter, referred to as “NAT”) function and a network address port translation (hereinafter, referred to as “NAPT”) function.

The NAT and NAPT functions are to exchange private IP addresses and global IP address with each other, and by these functions, the devices to which private IP addresses are assigned on the LAN are enabled to communicate with devices on the Internet (since the “NAT” and the “NAPT” are the same in the operation characteristic, these will hereinafter be referred to as “NAT” when it is unnecessary to distinguish them from each other).

When the router having the NAT function is used, it is easy to establish connection with devices on the Internet from devices within a LAN having private IP addresses. On the contrary, it is generally impossible to freely establish connection with devices within a LAN having private IP addresses from devices on the Internet.

It is generally called “to go beyond NAT” or “to pass through NAT” to transmit information from a device on the Internet to a device within a LAN beyond the router having the NAT function.

Technologies to solve this include those called “static NAT”, “port forwarding”, and the like. When the static NAT function is used, it is necessary that the user himself/herself presets a static NAT table in the router. The entries in the static NAT table that are necessarily set are the private IP address and port number of the device within the LAN with which connection is to be established and an unused port number of the router.

When connection is desired to be established with a device within a LAN from a device on the Internet, the user specifies a pair of the global IP address of the router and a port number of the router set in the static NAT table, and performs packet transmission. The router that has received the packet collates it with the entries in the static NAT table preset by the user himself/herself, replaces the destination of the packet with the private IP address and port of the device within the LAN in the entries, and transfers the packet into the LAN.

The use of the static NAT function enables communication with devices within a LAN to be established from devices on the Internet. However, when the static NAT function is used, not only it is necessary for the user to preset the static NAT table but also the setting is complicated for end users having no knowledge on IP addresses. In addition, there is a problem that, when the global IP address of the router having the static NAT function is dynamically assigned by the point-to-point protocol (PPP) or the dynamic host configuration protocol (DHCP), it is difficult for the user to grasp the address, and thus when connection to a LAN over the Internet is established, the connection destination cannot be identified.

Conventional methods to enable connection from a wide area network (hereinafter, referred to as “WAN”) such as the Internet to a LAN by easily identifying the device with which connection is established without performing the complicated setting of the static NAT table include a method using the universal plug and play NAT traversal (UPnP-NAT traversal) technology and a method disclosed in Patent Reference 1.

The UPnP-NAT traversal method can be used on condition that the router is provided with the universal plug and play Internet gateway device (UPnP-IGD) function. The UPnP-IGD is an industry standard issued by the UPnP forum, and is mounted on many broadband routers at present. According to the UPnP-NAT traversal method, devices within a LAN can establish TCP/IP connection to the router to which the devices are connected, call the UPnP-IGD function, and refer to and set the static NAT table in the router.

That is, according to the UPnP-NAT traversal method, the devices within a LAN can set the static NAT table so that communication with the devices themselves from the Internet can be automatically started without the user manually performing the complicated setting. The acquisition of the IP address and port of the WAN in that case can be automatically performed by the devices as well.

However, there is a problem that, when the devices within a LAN do not preset the static NAT table of the UPnP-IGD, the UPnP-IGD of the router cannot be directly operated from the devices on the Internet, and thus connection with devices within a LAN from devices on the Internet cannot started at an arbitrary point of time. On the other hand, there is a problem that, when the devices within a LAN preset the static NAT table of the UPnP-IGD, security of communication cannot be ensured since connection with devices within a LAN can be indiscriminately established at all times from any device on the Internet. Further, when a router not having the UPnP-IGD function is used, the UPnP-NAT traversal method cannot be applied.

As a method for establishing connection with devices within a LAN from devices on the Internet, a communication method is also disclosed that ensures security of communication and does not require a router having a special function (see, for example, Patent Reference 1).

According to the method disclosed in Patent Reference 1, a server device for NAT passage is provided on the Internet, and the devices within a LAN periodically transmit a user datagram protocol (UDP) packet to the server device. The server device can establish communication beyond the NAT from the server device on the Internet to the devices within a LAN by transmitting a return packet to the devices within a LAN as a reply to the UDP packet when necessary.

In such a method, while the setting that enables reception of communication from any device on the Internet is performed according to the static NAT function and the UPnP-IGD method, basically, only the return UDP packet from the server is allowed to pass through the LAN and when the devices stop the periodical transmission of the UDP packet, connection from the Internet is automatically disabled. Since security is high and operation is possible with a router having the simple NAT function, the router having the UPnP-IGD function is unnecessary and connection can be started at any point of time from devices on the Internet to devices within a LAN.

Patent Reference 1: Japanese Patent No. 3445986

### DISCLOSURE OF INVENTION

### Problems that Invention is to Solve

As described above, starting communication with devices within a LAN from devices on the Internet beyond the NAT generally requires high processing load and processing time. Moreover, this is intended for one-to-one communication, and when given pieces of information are desired to be collectively retrieved or acquired from plural devices belong to an other same LAN on the network, communication with the server device for NAT passage and a communication channel generating operation involved in the communication are always necessary for each connection destination.

On the other hand, when future networking of home electric appliances is considered, it is predicted that a usage will increase such that the user collectively acquires AV content lists and AV contents from many communication devices having AV functions which are present within the user's home LAN by using a mobile communication device outside home. In such a case, according to the above-described conventional technology, the number of times of the communication with the server device designed specifically for NAT passage and the number of times of a communication channel generating operations involved in the communication increase, resulting in a load on the processing and a load on the traffic. In addition, since the user establishes connection every time, there is a problem that the amount of operation increases.

The communication method using the static NAT table and the communication method using the UPnP-NAT traversal technology are also intended for one-to-one communication, and when a device on the Internet acquires information from plural devices within a LAN, likewise, the load on the traffic involved in the communication occurs and user's operation is required, for each device as connection destination.

In consideration of the above-mentioned problems, an object of the present invention is to provide a communication system capable of reducing the amount of communication and the load associated with the user's operation when a terminal device connected to the Internet and plural communication devices within a LAN perform communication with each other.

### Means to Solve the Problems

In order to achieve the above object, a communication system includes: a terminal device; and plural communication devices existing within a LAN connected to the terminal device through the Internet. The terminal device includes: an intra-LAN information storing unit which stores information about processing performed by the plural communication devices; a determining unit which determines one representative device which is a communication device that serves as a representative, from among the plural communication devices based on the information stored in the intra-LAN information storing unit; a request transmitting unit which transmits a request for information about the communication device within the LAN, to the representative device determined by the determining unit; and a response receiving unit which receives a response to the request from the representative device. The communication device includes: a request receiving unit which receives a request for the information about the communication device within the LAN, from the terminal device; a device information acquiring unit which acquires the information about the communication device within the LAN; and a response transmitting unit which transmits, in the case where the request receiving unit receives the request, from the terminal device, the information acquired by the device information acquiring unit to the terminal device as a response to the request.

The terminal device, of the present invention, connected to the Internet communicates with plural communication devices within a LAN connected to the Internet. The terminal device includes: an intra-LAN information storing unit which stores information about processing performed by the plural communication devices; a determining unit which determines one representative device which is a communication device that serves as a representative, from among the plural communication devices based on the information stored in the intra-LAN information storing unit; a request transmitting unit which transmits a request for information about the communication device within the LAN, to the representative device determined by the determining unit; and a response receiving unit which receives a response to the request from the representative device.

The communication device, of the present invention, within a LAN includes plural communication devices and communicates with a terminal device through the Internet connected to the LAN. The communication device includes: a request receiving unit which receives a request for the information about the communication device within the LAN, from the terminal device; a device information acquiring unit which acquires the information about the communication device within the LAN; and a response transmitting unit which transmits, in the case where the request receiving unit receives the request from the terminal device, the information acquired by the device information acquiring unit to the terminal device as a response to the request.

In this way, in the communication system of the present invention, when the terminal device acquires the information from the communication device within the LAN, the representative device determined by the terminal device acquires the information about the communication device within the LAN, and transmits it to the terminal device. Consequently, there is no need for the terminal device to communicate with each of plural communication devices existing within the LAN, and thus the amount of communication is reduced. Moreover, the user can collectively acquire the information possessed by plural communication devices within the LAN only by making a request once from the terminal device.

Moreover, the terminal device of the present invention is capable of storing the information about the processing performed by the communication device within the LAN and determining the representative device based on the information. That is, the terminal device is capable of determining the representative device without requiring any user operation such as a determination. Moreover, the information about plural communication devices within the LAN can be received by communication with the representative device.

Moreover, the communication device of the present invention is capable of acquiring the information about the communication device within the LAN and transmitting the acquired information as a response to the request from the terminal device. That is, the communication device is capable of causing the terminal to acquire the information about an other communication device within the LAN.

In the communication system and the terminal device according to the present invention, in the case where the response receiving unit does not receive the response to the request from the representative device, the determining unit further determines, as a new representative device, a communication device within the LAN other than the communication device previously determined as the representative device, based on the information stored in the intra-LAN information storing unit.

With this structure, in the case where the response from the representative device is not received, that is, when communication with the representative device is disabled, the terminal device determines a new representative device from among plural communication devices within the LAN based on the stored information, and communicates with the representative device. Consequently, for example, the information about plural devices within the LAN can be acquired from the terminal device without requiring the user to perform an operation such as the selection of a new representative device or setting.

In the communication system and communication device of the present invention, the request receiving unit further receives the request for the information about the communication device from an other communication device within the LAN, and in the case where the request receiving unit receives the request from the other communication device within the LAN, the response transmitting unit further transmits the information about the communication device to the other communication device within the LAN as a response to the request.

With this structure, when an other communication device within the LAN is determined as the representative device, the communication device of the present invention is capable of transmitting information in response to a request from the representative device. That is, the communication device of the present invention is capable of exerting the function as the representative device and the function of performing information transmission and the like in response to a request from the representative device.

With this structure, the communication device previously acquires and stores the information about the communication devices within the LAN. Consequently, for example, when making a request from the terminal, the user can acquire the information that plural communication devices within the LAN have collectively and more quickly.

As described above, when the communication system, the terminal device, and the communication device of the present invention acquire information from plural communication devices within the LAN, there is no need for the terminal device to communicate with each communication device, and thus the overall amount of communication in acquisition of the information and the load for the user's operation can be reduced.

Further, the present invention may be implemented as a method with the characteristic components of the communication system, the communication device, and the terminal device of the present invention as its steps, may be implemented as a program including the steps, may be implemented as a storage medium such as a CD-ROM storing the program, and may be implemented as an integrated circuit. The program may be distributed through a transmission medium such as a communication network.

### EFFECTS OF THE INVENTION

The present invention provides a communication system, a communication device, and a terminal device capable of reducing the amount of communication and the load associated with the user's operation when the terminal device connected to the Internet and the communication devices within a LAN communicate with each other.

Consequently, the user can easily acquire information from plural devices within the LAN by using a terminal device connected to the Internet, and usability is improved. In addition, since the amount of communication is reduced, for example, the present invention can contribute to the reduction in the amount of communication traffic on the Internet.

### BRIEF DESCRIPTION OF DRAWINGS

FIG. 1 is a view showing the structure of a communication system of a first embodiment.

FIG. 2 is a functional block diagram showing the functional structures of a terminal and devices within a LAN in the communication system of the first embodiment.

FIG. 3 is a view showing a communication sequence to register the device ID of the terminal in the plural devices within the LAN in order that the devices within the LAN perform communication with the terminal.

FIG. 4 is a view showing a GUI with which the user registers the device ID of the terminal in the plural devices within the LAN.

FIG. 5 is a view showing a GUI with which the user selects the devices, within the LAN, whose device IDs are registered.

FIG. 6 is a view showing a communication sequence at the time when the terminal registers the device IDs of the devices within the LAN in an intra-LAN device list used for performing communication with plural devices within the LAN.

FIG. 7 is a view showing a communication sequence to update the intra-LAN device list.

FIG. 8 is a view showing a GUI with which the user selects devices, within the LAN, to be registered in the terminal.

FIG. 9 is a view showing a communication sequence when the user provides an instruction to perform batch acquisition of the content lists of the devices within the LAN from the terminal in the first embodiment.

FIG. 10 is a view showing the structure of a communication system of a second embodiment.

FIG. 11 is a view showing a communication sequence at the time when the user provides an instruction to perform batch acquisition of the content lists of the devices within a LAN from the terminal in the second embodiment.

FIG. 12 is a view showing a communication sequence in the batch acquisition of the content lists of the devices within the other LAN performed subsequently to the end of the communication sequence shown in FIG. 11.

FIG. 13 is a view showing a GUI with which the user selects a LAN to be searched.

FIG. 14 is a view showing a GUI to individually select devices within a specific LAN as the object to be searched for.

FIG. 15 is a view showing the structure of a communication system of a third embodiment.

FIG. 16 is a functional block diagram showing the functional structure of a device having a cache function in the communication system of the third embodiment.

FIG. 17 is a view showing a communication sequence of communication by a cache function.

FIG. 18 is a view showing a communication sequence at the time when the user provides an instruction to perform batch acquisition of the content lists of the devices within a LAN from the terminal in the third embodiment.

FIG. 19 is a view showing the structure of a communication system of a fourth embodiment.

FIG. 20 is a functional block diagram showing the functional structure of a device in the communication system of the fourth embodiment.

FIG. 21 is a view showing the information flow at the time when a content downloaded from a content server to a device is acquired by the terminal in the communication system of the fourth embodiment.

FIG. 22 is a view showing the information flow at the time when the terminal acquires the license key of the content to be reproduced in the communication system of the fourth embodiment.

### NUMERICAL REFERENCES

1 Device side communication unit
2, 11 Input unit
3, 12 Display unit
4 Device ID storing unit
5, 16 Content storing unit
6 Device control unit
7 Cache storing unit
8 License key storing unit
10 Terminal side communication unit
13 Device list storing unit
14 Representative device preference storing unit
15 Terminal control unit
100 Internet
101, 301, 501, 601 First communication channel
102, 302, 502, 602 Second communication channel
303 Third communication channel
103, 304, 503, 603 NAT passage server
105, 305, 505, 605 External network
119, 319, 329, 519, 619 NAT router
110, 310, 320, 510, 610 LAN
111, 112, 113, 311, 312, 313, 321, 322, 323, 511, 512, 513, 611, 612, 613 Device
121, 331, 521, 621 Terminal
604 Content server

### BEST MODE FOR CARRYING OUT THE INVENTION

Hereinafter, a best mode for carrying out the present invention will be described with reference to the drawings.

### First Embodiment

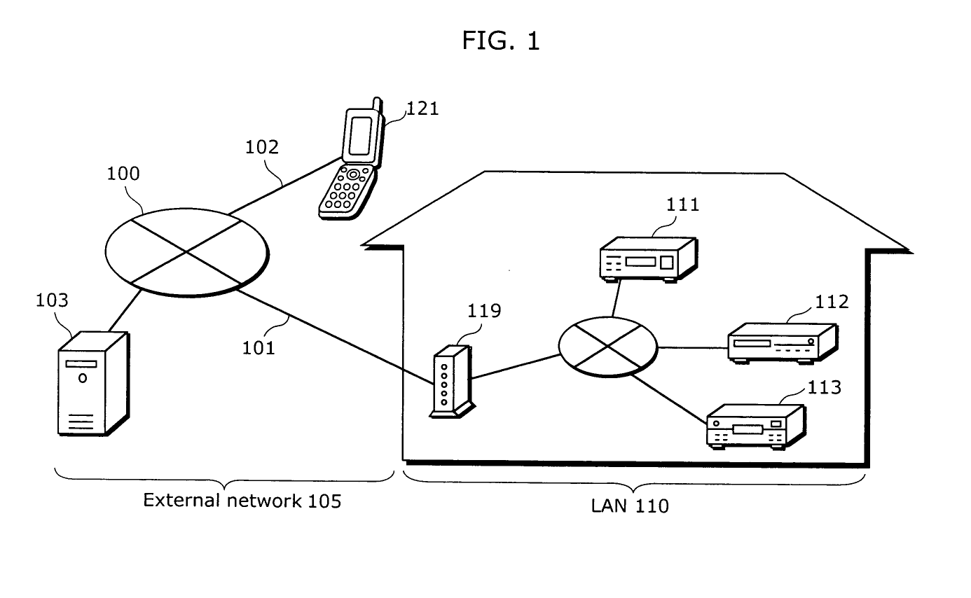

A first embodiment of the present invention will be described using FIGS. 1 to 9.

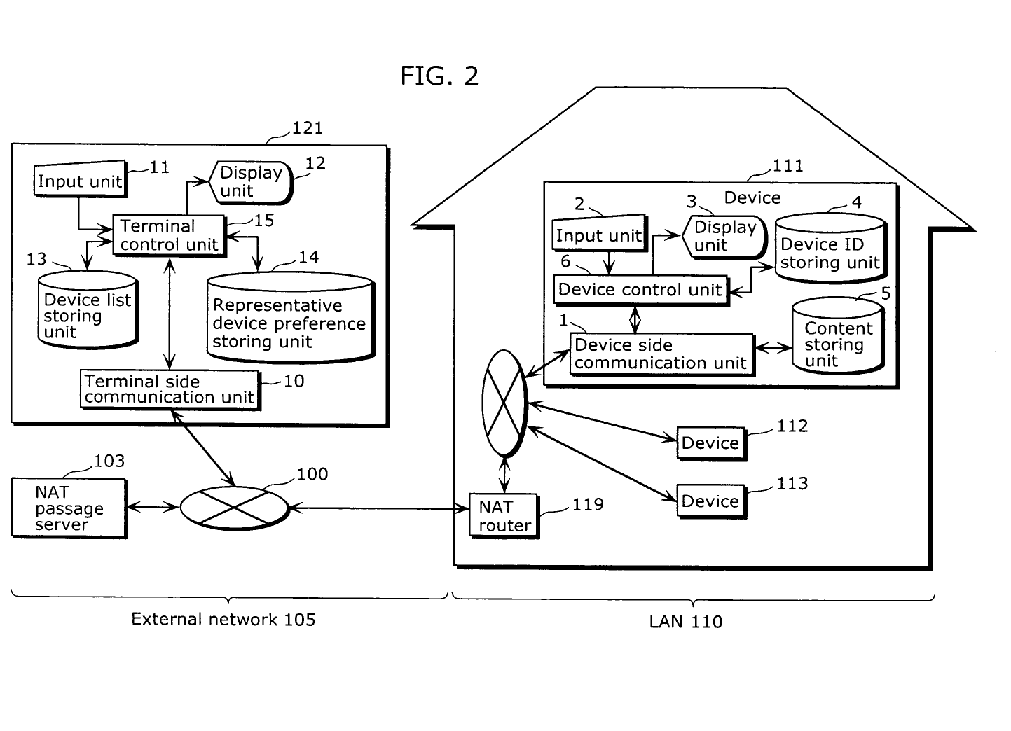

First, using FIGS. 1 and 2, the structure of a communication system of the first embodiment will be described.

FIG. 1 is a view showing the structure of the communication system of the first embodiment. The communication system shown in FIG. 1 is a system for allowing the user who has plural devices existing within the same LAN to acquire information about the devices such as contents possessed by the devices through the Internet, for example, from outside the home.

As shown in FIG. 1, the communication system of the first embodiment includes an external network 105 and a LAN 110.

The external network 105 has the Internet 100, a terminal 121, and a NAT passage server 103, and the terminal 121 and the NAT passage server 103 are connected to the Internet 100.

The LAN 110 has a NAT router 119, a device 111, a device 112, and a device 113, and the NAT router 119, the device 111, the device 112, and the device 113 are connected together so as to be capable of communicating with one another. The LAN 110 is connected to the Internet 100 through the NAT router 119.

The communication channel through which the NAT router 119 and the Internet 100 communicate with each other is designated as a first communication channel 101, and the communication channel through which the terminal 121 and the Internet 100 communicate with each other is designated as a second communication channel 102.

In the following description, the devices within a LAN indicate the devices provided in the LAN. That is, the devices within a LAN are devices capable of communicating with devices on the Internet through the NAT router provided in the LAN.

The terminal 121 is a device for performing communication with the devices within the LAN 110, and is, for example, a mobile telephone. The device 111, the device 112, and the device 113 are devices storing contents such as moving images, and are, for example, hard disk recorders.

The NAT router 119 is a router having the above-described NAT function, and is a router device that interconverts between global IP addresses and private IP addresses for allowing the devices within the LAN 110 and devices on the Internet 100 to communicate with each other.

The device 111, the device 112, the device 113, and the terminal 121 each have an identifier for identifying the device. Hereinafter, the identifier will be called “device ID”.

The device 111, the device 112, and the device 113 are each an example of the communication device of the present invention. These devices are control points defined by the UPnP-DA (device architecture) standard and have the CDS (contents delivery service) function of the UPnP-AV standard (hereinafter, referred to as “CDS function”), and the contents possessed by the devices can be provided to other devices.

In order to protect the contents provided by the CDS function from being watched by outsiders, a password for performing authentication when the device is accessed by other devices is assigned to each of the device 111, the device 112, and the device 113.

Moreover, for authentication at the time when the CDS function is provided to an other device, the user can register a device ID which is an identifier of a device permitted to be provided with the CDS function, in each of the device 111, the device 112, and the device 113. That is, the device 111, the device 112, and the device 113 provide the CDS function only when a correct password is transmitted from a device having a registered device ID.

The password and the device ID are held in a storing unit or the like included in the device 111, the device 112, and the device 113. Components provided in the device 111, and the like will be described later using FIG. 2.

The NAT passage server 103 is a server for establishing communication with the devices within the LAN 110 from the terminal 121. The terminal 121 can start communication with the devices within the LAN 110 using the NAT passage server 103 even when the NAT router 119 is present on the channel. As the method to realize this communication, the technology disclosed in Patent Reference 1 is used.

Specifically, the devices within the LAN 110 periodically transmit a UDP packet to the NAT passage server 103. The NAT passage server 103 is capable of transmitting information to the devices within the LAN 110 at any time as a response to the UDP packet. Under this circumstance, when receiving a request for connection with a device such as device 111 within the LAN 110 from the terminal 121, the NAT passage server 103 transmits a connection request to the device 111.

After receiving the connection request, the device 111 establishes communication with the NAT passage server 103, and transmits, to the NAT passage server 103, connection information which includes the port number for directly communicating with devices on the Internet and the global IP address of the NAT router 119 and which is set in the NAT router 119 when communication is established.

The NAT passage server 103 transmits the connection information to the terminal 121. The terminal 121 establishes connection with the device 111 using the received connection information. Thereby, the terminal 121 and the device 111 can directly communicate with each other thereafter.

As described above, the NAT passage server 103 is a device for establishing communication with the devices within the LAN 110 from the terminal 121, and does not take part in the information exchange between the terminal 121 and the devices within the LAN after communication is established. For this reason, the NAT passage server 103 always performs the above-described operation when communication with the devices within the LAN from the terminal 121 is started, and the illustration and description of the NAT passage server in the functional structure of the devices and the communication sequences shown in FIGS. 2 to 9 are omitted. The illustration and description of the NAT router 119 are also omitted since the NAT router 119 performs only the IP address conversion and the like and is not related to the features of the communication system.

FIG. 2 is a functional block diagram showing the functional structure of the terminal 121 and the device 111 in the communication system of the first embodiment. The functional structures of the device 112 and the device 113 are similar to that of the device 111, and description thereof is omitted.

For the device 111, the description of the function associated with the reproduction of contents and the like is omitted, and only characteristic components in the communication system of the present invention will be described. Likewise, as for the terminal 112, only characteristic components in the communication system of the present invention will be described.

As mentioned above, the device 111 is a device storing contents such as moving images, and is, for example, a hard disk recorder. The device 111 has a device side communication unit 1, an input unit 2, a display unit 3, a device ID storing unit 4, a content storing unit 5, and a device control unit 6.

The device side communication unit 1 is a processor for exchanging information with an other device within the LAN 110 and the terminal 121. The device side communication unit 1 realizes the information receiving or transmitting function possessed by each of the request receiving unit, the response transmitting unit, the identifier receiving unit, and the identifier transmitting unit in the communication device of the present invention. The generation of information to be transmitted, the retrieval of necessary information from the received information, and the like are performed by the device control unit 6.

The input unit 2 is an example of the accepting unit in the communication device of the present invention, and is a processing unit that accepts the device ID of the terminal 121 and the like that the user inputs to the device 111.

The display unit 3 is a liquid crystal screen or the like for providing the user with a GUI (graphical user interface) for displaying information and inputting instructions. The device ID storing unit 4 is an example of the identifier storing unit in the communication device of the present invention, and is a storage device for storing the device ID of the device 111 itself and IDs of other devices to authenticate communication.

The content storing unit 5 is a storage device for storing contents such as moving images. The device control unit 6 is a processing unit controlling and executing the processing such as communication and authentication performed by the device 111, and holds the password assigned to the user. The device control unit 6 is an example of the device information acquiring unit in the communication device of the present invention.

Like the device 111, the device 112 and the device 113 each have the device side communication unit 1, the input unit 2, the display unit 3, the device ID storing unit 4, the content storing unit 5, and the device control unit 6.

The terminal 121 is a device for performing communication with the devices within the LAN 110, and is, for example, a mobile telephone. The terminal 121 has a terminal side communication unit 10, an input unit 11, a display unit 12, a device list storing unit 13, a representative device preference storing unit 14, and a terminal control unit 15.

The terminal side communication unit 10 is a processing unit for exchanging information with other devices such as the devices within the LAN 110. The information transmitting or receiving function possessed by each of the request transmitting unit and the response receiving unit in the terminal device of the present invention is realized by the terminal side communication unit 10.

The input unit 11 is buttons or the like for allowing the user to input instructions and selections to the terminal 121. The display unit 12 is a liquid crystal screen or the like for providing the user with a GUI for displaying information and inputting instructions.

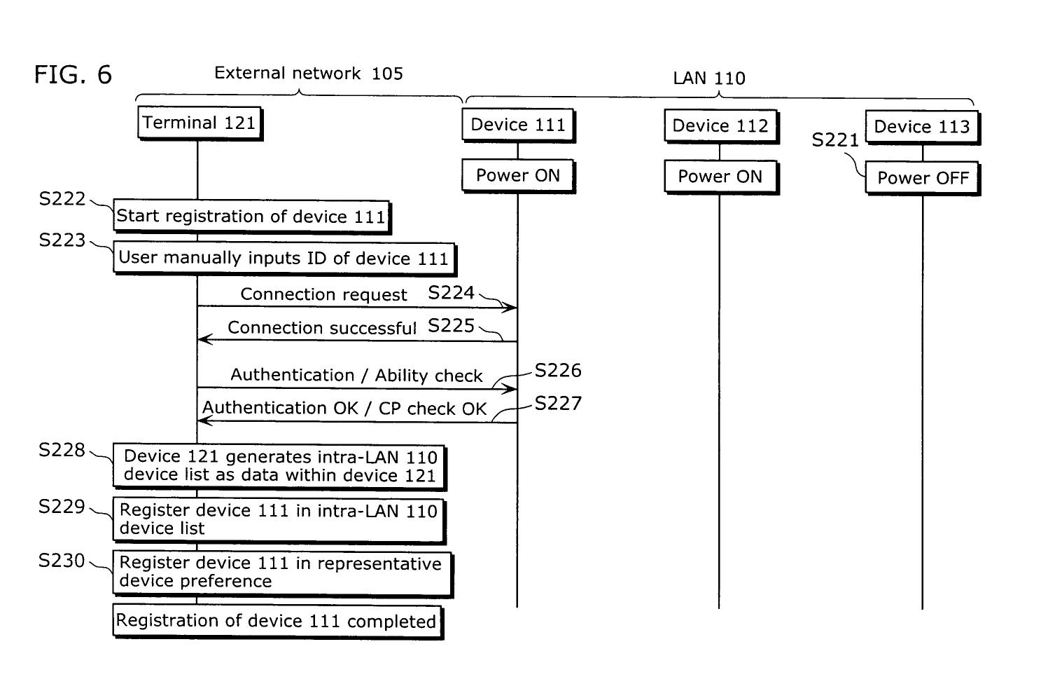

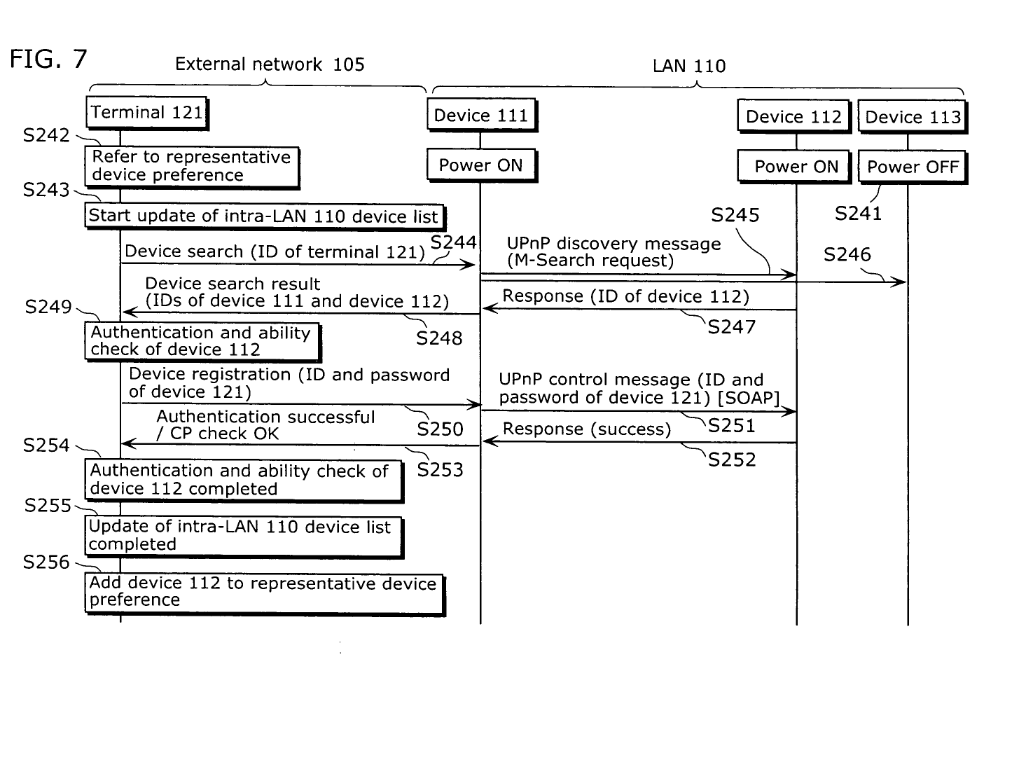

The device list storing unit 13 is a storing unit storing the device IDs of the devices within the LAN 110 as a list of intra-LAN 110 devices. The operation to register the device IDs of the devices within the LAN 110 will be described later using FIGS. 6 and 7.

The representative device preference storing unit 14 is an example of the intra-LAN information storing unit in the terminal device of the present invention, and is a storing unit storing an intra-LAN 110 representative device preference. Here, the representative device is a device that communicates with the terminal 121 as a representative of plural devices within the LAN 110 when the terminal 121 and the devices within the LAN 110 perform communication.

The intra-LAN 110 representative device preference is data for determining the representative device within the LAN 110, and information about the processing performed by the devices within the LAN 110 is recorded. Specifically, the device ID of the device having the UPnP control point function is registered. The operation of the terminal 121 to register the device ID in the intra-LAN 110 representative device preference will be described later using FIGS. 6 and 7.

The terminal control unit 15 is a processing unit controlling and executing the processing such as communication and the determination of the representative device performed by the terminal 121, and holds the device ID of the terminal 121. The representative device determining function of the representative determining unit in the terminal device of the present invention and the determining unit's function of determining whether the individual information about the devices within the LAN satisfies a predetermined criterion or not are realized by the terminal control unit 15.

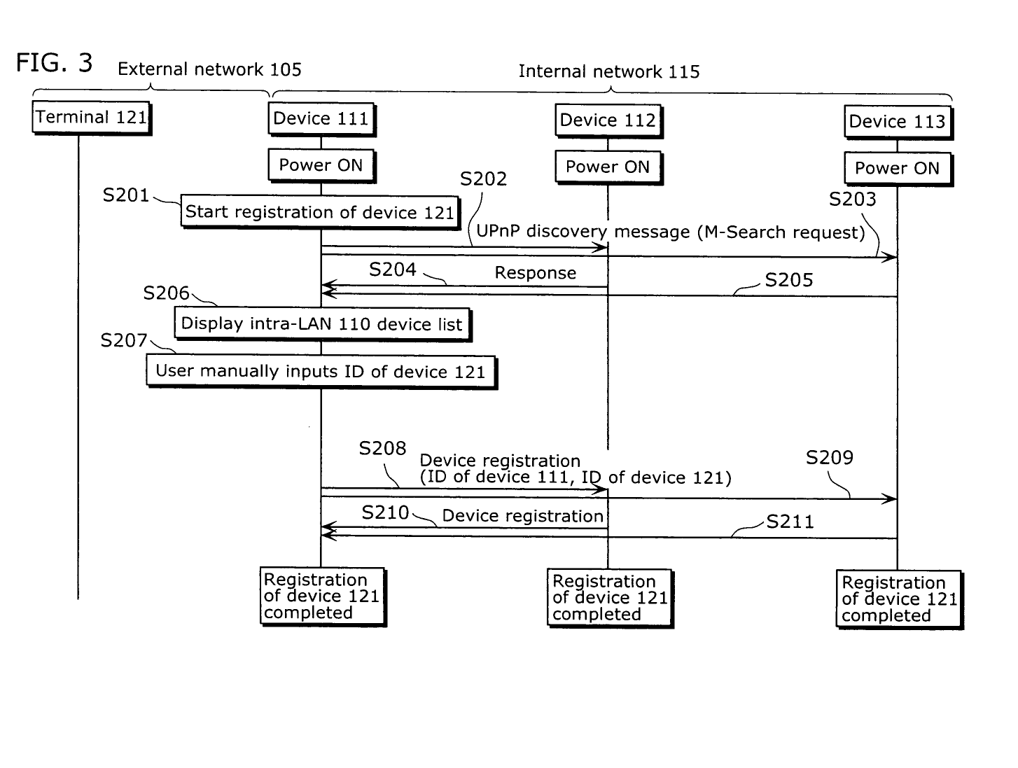

Next, the operation of the communication system of the first embodiment will be described using FIGS. 3 to 9.

FIG. 3 is a view showing a communication sequence to register the device ID of the terminal 121 in the devices within the LAN 110 in order that the devices within the LAN 110 communicates with the terminal 121.

Hereinafter, description will be given on the assumption that the user previously knows the device ID of the terminal 121 and the device ID of the device 111, and the device ID of the device 111 is already registered in the device 112 and the device 113, that is, the device ID of the device 111 is stored in the device ID storing unit 4 of each device.

First, the device 111 starts the registration of the device ID of the terminal 121 on the user's predetermined instruction from the input unit 2 (S201).

The device control unit 6 of the device 111 transmits an M-Search request which is a UPnP discovery message, to the other devices connected to the LAN 110; that is, the device 112 and the device 113 in the first embodiment, through the device side communication unit 1 (S202, S203).

To the M-Search request, the device 112 and the device 113 make a response indicating that they are present (S204, S205). The processing such as the response made by the device 112 and the device 113 is performed by the device control unit 6 of each device, and the transmission and reception of information is performed by the device side communication unit 1 of each device.

The device side communication unit 1 of the device 111 receives the response, and based on the response, the device control unit 6 displays a list of the devices on the display unit 3 in order to notify the user that the device 111, the device 112, and the device 113 in a communication-capable state are present within the LAN 110 (S206).

Then, the user inputs the device ID of the terminal 121 by operating the input unit 2 (S207). The device 111 has a mechanism that only requires the user to manually input the device ID of the terminal 121 once so that the device ID of the terminal 121 is registered in the device 111, the device 112, and the device 113.

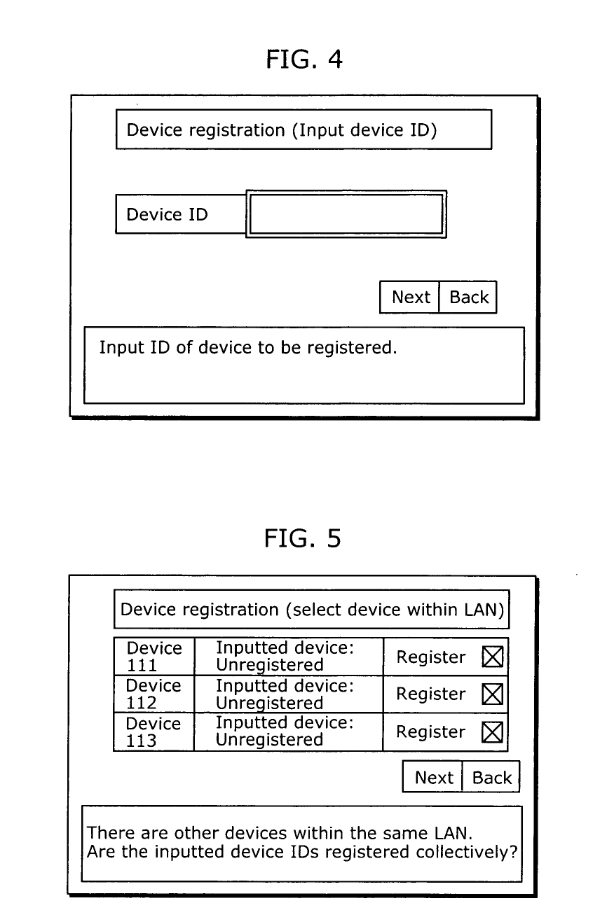

Specifically, the device control unit 6 of the device 111 displays a GUI shown in FIG. 4 on the display unit 3.

FIG. 4 is a view showing the GUI for the user to register the device ID of the terminal in plural devices within the LAN.

The device control unit 6 of the device 111 displays the GUI shown in FIG. 4 on the display unit 3. The device ID of the terminal 121 is inputted by the user from this GUI, and the inputted device ID of the terminal 121 is temporarily held by the device control unit 6.

Then, the device control unit 6 of the device 111 displays a GUI shown in FIG. 5 on the display unit 3.

FIG. 5 is a view showing the GUI for the user to select the devices within the LAN in which the device ID of the terminal 121 is to be registered.

When the device 111, the device 112, and the device 113 within the LAN 110 are selected with the check boxes that respectively indicate the devices and the button labeled with “Next” is clicked by the user on the GUI shown in FIG. 5, the device control unit 6 accepts the click, and generates a terminal registration request including the device ID of the terminal 121 and the device ID of the terminal 111. The device side communication unit 1 transmits the generated terminal registration request to each of the device 112 and the device 113 (S208, S209).

The device 112 and the device 113 receive the terminal registration request, and after checking that the device ID of the device 111 is registered in themselves, register the device ID of the terminal 121 in themselves.

Moreover, at the device 111, the device ID of the terminal 121 is also registered in the device. That is, at each device, the device ID of the terminal 121 is stored in the device ID storing unit 4. Further, the device 112 and the device 113 transmit a response indicating the success in the terminal registration to the device 111 (S210, S211), and the registration is completed.

By the above-described communication sequence, the device ID of the terminal 121 is registered in each of the device 111, the device 112, and the device 113. In other words, it is possible to input the device ID in the devices at a time, while the device ID of the terminal is conventionally required to be manually inputted by the user himself/herself through a GUI or the like of each device on a device-by-device basis.

Specifically, in the communication system of the first embodiment, the device ID of the terminal permitted to establish connection (the terminal 121 in the first embodiment) can be collectively registered in the devices selected from among all the devices within the LAN 110 from one device within the LAN 110 (the device 111 in the first embodiment).

Further, the device ID is registered in the device ID storing unit 4 of each device. Each device can determine whether communication is possible or impossible according to whether the information transmitted from an other device includes the registered device ID or not. That is, each device can refuse the connection request and the like from unregistered devices.

In other words, the communication authority of plural devices within the LAN 110 for other devices can be set with a light load on the user. This can reduce the user's operation associated with the setting of the communication authority for other devices.

FIG. 6 is a view showing a communication sequence where the terminal 121 registers the device ID of the device 111 in the intra-LAN 110 device list used for communicating with the devices within the LAN 110.

First, it is assumed that the device 113 is turned off (S221).

At the terminal 121, the registration of the device 111 is started on a predetermined instruction provided by the user from the input unit 11 (S222).

The device ID of the device 111 is inputted by the user's operation of the input unit 11 (S223). The terminal control unit 15 accepts the input, and establishes communication with the device 111 through the terminal side communication unit 10 by the above-described communication method using the NAT passage server 103. After communication is established, a connection request is transmitted to the device 111 through the second communication channel 102, the Internet 100, the first communication channel 101, and the NAT router 119 (S224).

The terminal 121 receives the response indicating the success in connection (S225), and performs authentication and an ability check on the device 111 (S226, S227). The ability check is to judge what kind of processing the device can perform and how high the processing power of the device is, that is, to acquire the individual information which is information about the processing performed by the device and judge whether the information satisfies a predetermined criterion or not. In the present embodiment, the predetermined criterion is to have the UPnP control point function, and when the individual information indicates that the device has the UPnP control point function, it is judged that the information satisfies the predetermined criterion. This judgment is made by the terminal control unit 15 of the terminal 121.

Specifically, the terminal 121 is authenticated by the device 111 by transmitting the password of the device 111 from the terminal 121. The terminal 121 checks the ability of the device 111, for example, as to whether the device 111 is a UPnP control point (designated “CP” in the figures including FIG. 6) or not.

Thereafter, the terminal control unit 15 of the terminal 121 generates the intra-LAN 110 device list in the device list storing unit 13 in the terminal 121 (S228). The intra-LAN 110 device list is a list for holding the device IDs of the devices connected within the LAN 110. The terminal control unit 15 registers the device ID of the device 111 in the intra-LAN 110 device list (S229).

By having such an intra-LAN 110 device list, the terminal 121 can grasp the presence of devices capable of communicating with the terminal 121 which are present within the LAN 110.

In addition, the intra-LAN 110 representative device preference is held in the representative device preference storing unit 14 as data within the terminal 121. While the device IDs of all the communication-capable devices existing within the LAN 110 are registered in the intra-LAN 110 device list, the device IDs of the devices that can be the representative device are registered in the intra-LAN 110 representative device preference.

By referring to the intra-LAN 110 representative device preference, the terminal 121 can determine the representative device within the LAN 110 without requiring the user's operation when collectively acquiring information from the devices within the LAN 110.

In the first embodiment, plural device IDs of devices that has been previously connected and that has been proved to have the UPnP control point function are stored in the intra-LAN 110 representative device preference. The device 111 is a UPnP control point, and is added to the intra-LAN 110 representative device preference by the terminal control unit 15 (S230).

When plural device IDs are registered in the intra-LAN 110 device preference, the priority as the representative device is determined based on the abilities of the devices obtained in the ability check, and the device having the highest priority is selected as the representative device. The processing on the intra-LAN 110 representative device preference is performed by the terminal control unit 15.

The registration of device IDs in the intra-LAN 110 device list and the intra-LAN 110 representative device preference, and the selection of the representative device are performed by the terminal control unit 15.

The registration of the device 111 in the terminal 121 is completed by the above-described operation.

FIG. 7 is a view showing a communication sequence at the time when the intra-LAN 110 device list is updated. With this update, the device ID of the device 112 that is not registered in the intra-LAN 110 device list is added to the intra-LAN 110 device list.

In the description given below, unless otherwise specified, the processing performed by devices such as the device 111, the device 112, and the device 113 is performed by the device control unit 6 of each device, and the transmission and reception of information is all performed by the device side communication unit 1 of each device. The processing performed by a terminal such as the terminal 121 is performed by the terminal control unit 15, and the transmission and reception of information is all performed through the terminal side communication unit 10.

It is assumed that the device 113 is turned off (S241).

After the communication sequence, shown in FIG. 6, at the time when the device ID of the device 111 is registered in the terminal 121, the terminal 121 automatically refers to the intra-LAN 110 representative device preference (S242), and starts the update of the intra-LAN 110 device list (S243).

The terminal 121 transmits a device search request including the device ID of the terminal 121, as a request for information about the devices within the LAN 110 to the device 111 determined as the representative device by the reference to the intra-LAN 110 representative device preference (S244). The device search request is a request for the search for the communication-capable devices within the LAN 110.

The device 111 having received the device search request transmits an M-Search request which is a UPnP discovery message, to the devices within the LAN 110. In the first embodiment, an M-Search request to request for a response is transmitted to the device 112 and the device 113 (S245, S246).

The device ID of the terminal 121 is added to the request header of the M-Search request by the device control unit 6 of the device 111.

Next, the device 112 and the device 113 which are destinations of the M-Search request check the device ID of the terminal 121 included in the M-Search request, and return a response only when the device ID matches the device ID registered in their device ID storing units 4.

In other words, when the device IDs do not match, no response is returned. When they return a response to the M-Search request, they include their own device IDs in the response.

In the case of the first embodiment, the device ID of the terminal 121 is already registered in the device 112 as described using the sequence diagram of FIG. 3, and the device 112 transmits a response including the device ID of the device 112 in response to the M-Search request (S247). Although the device ID of the terminal 121 is stored in the device 113, the device 113 does not respond to the M-Search request because it is turned off. Therefore, the device 111 receives only the response from the device 112 (S247).

The device 111 returns, as the device search result, the device ID of the device 111 and the device ID of the device 112 to the terminal 121 as information to identify the device 111 and the device 112 (S248). That is, the device ID of the terminal 112 that is not registered in the intra-LAN 110 device list of the terminal 121 is transmitted to the terminal 121.

The device 112 is registered in the intra-LAN 110 device list and the intra-LAN 110 representative device preference using the device ID of the device 112 in the operation of the terminal 121 shown below.

After receiving the device search result from the device 111, the terminal 121 starts the operation to cause the device 112 to authenticate the terminal 121 and the ability check of the device 112 in order to register the device ID of the device 112 in the terminal 121 (S249).

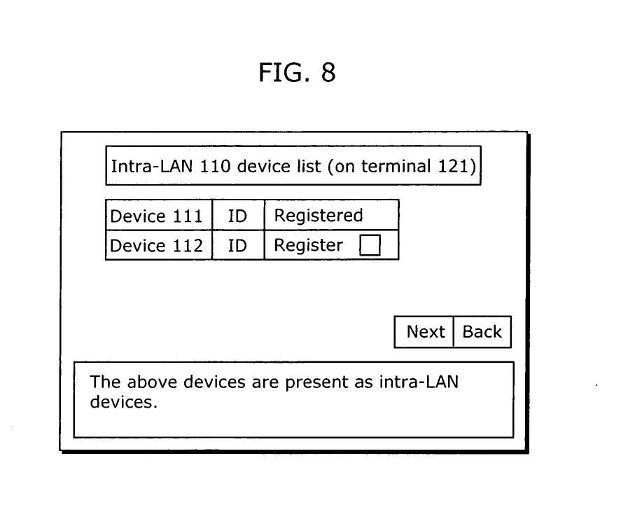

The terminal 121 displays the connection condition of the devices within the LAN 110 to the user by a GUI as shown in FIG. 8.

FIG. 8 is a view showing the GUI for allowing the user to select the device within the LAN 110 to be registered in the terminal 121. The GUI is displayed on the display unit 12.

When the check box corresponding to the device 112 on the GUI shown in FIG. 8 is checked by the user's operation of the input unit 11, the terminal 121 accepts the request to register the device 112. Thereafter, the terminal 121 prompts the user to input the password on the GUI.

When the correct password assigned to the device 112 is inputted and a predetermined operation is performed by the user, the terminal 121 transmits, to the device 111, a device registration request including the device ID of the terminal 121 and the password inputted by the user (S250).

When receiving the device registration request, the device 111 transmits a SOAP action request which is a UPnP control message, to the device 112 on the LAN 110 (S251). The SOAP action request includes the device ID of the terminal 121 and the password inputted by the user on the terminal 121.

The device 112 performs authentication of the terminal 121 using the information included in the SOAP action request. Specifically, the device 112 authenticates the terminal 121 only when the device ID of the terminal 121 included in the SOAP action request is stored in the device ID storing unit 4 of the device 112 and the password included in the SOAP action request matches its own password.

When succeeding in authentication, the device 112 transmits, to the device 111, a response including a content permitting device registration and a content indicating that the device 112 itself has the UPnP control point function (S252). The device 111 transmits, to the terminal 121, the response including the content permitting device registration and the content indicating that the device 112 itself has the UPnP control point function received from the device 112 (S253). That is, the device 111 transmits the individual information of the device 112. Thereby, the terminal 121 can acquire the individual information of the device 112 through the device 111 which is the representative device.

When the terminal 121 receives this response, the authentication of the device 112 and the ability check of the device 112 are completed (S254), the device ID of the device 112 is added to the intra-LAN 110 device list, and the update of the intra-LAN 110 device list is completed (S255). Then, since the device 112 has the UPnP control point function, the device ID of the device 112 is additionally recorded in the intra-LAN 110 representative device preference (S256).

As described above, in the communication system of the first embodiment, the device search request transmitted from the terminal 121 is transferred to the devices within the LAN 110 in order to update the intra-LAN 110 device list within the terminal 121. Specifically, the device 111 converts the device search request into the M-Search request within the LAN, searches for the devices within the LAN 110, and returns the device search result to the terminal 121 as a response. That is, by communicating only with the device 111 which is the representative device, the terminal 121 can grasp the presence of the communication-capable devices within the LAN 110, and it is unnecessary to try to establish connection with each device within the LAN. That is, the amount of communication, the amount of operation by the user, and the amount of processing by the terminal 121 can be reduced.

Moreover, only by checking whether the device ID of the terminal 121 included in the request header of the M-Search request transmitted from the device 111 has already been registered or not, the device 112 can check the communication authority of the device making the request. Thus, no load is imposed on the user. Further, only when the device ID of the terminal 121 has already been registered, that is, when the device 112 permits communication with the terminal 121, the device 112 responds to the M-Search request and the terminal 121 can grasp the presence of the device 112.

The device ID of the device 112 whose presence has been newly grasped is transmitted from the device 111 which is the representative device to the terminal 121. That is, it becomes possible to eliminate the input of the device ID of the device 112, while the user himself/herself is conventionally required to manually input the device ID of the device 112.

The user can easily register additional device in the intra-LAN 110 device list only by inputting only the password assigned to the device 112 without inputting the device ID at the terminal 121 using the transmitted device ID of the device 112. At the same time, since the ability check of the device 112 is performed, it is possible to add the device to the intra-LAN 110 representative device preference. That is, the communication system of the first embodiment is capable of reducing the amount of operation performed by the user when registering the devices within the LAN 110 at the terminal 121.

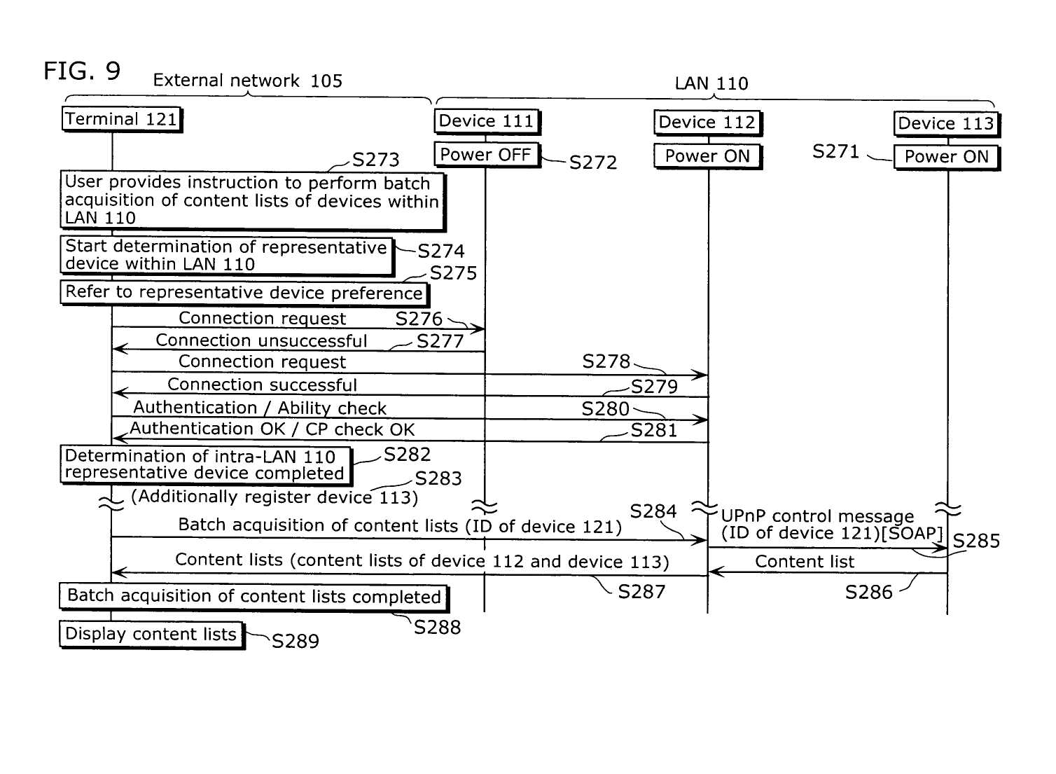

The device 113 which is turned off in the sequence diagram shown in FIG. 7 is turned on, and then, added to the intra-LAN 110 device list and to the intra-LAN 110 representative device preference like the device 112. The timing of the addition will be described later in the explanation of FIG. 9.

FIG. 9 is a view showing a communication sequence at the time when the user provides an instruction to perform batch acquisition of the content lists of the devices within the LAN 110 from the terminal 121.

The device 113 is turned on (S271), and the device 111 is turned off (S272).

First, at the terminal 121, an instruction to perform a content batch search on the devices within the LAN 110 is provided by the user's operation of the input unit 11 (S273). The terminal 121 starts the determination of the representative device of the LAN 110 to which a batch acquisition request is transmitted (S274).

The terminal 121 refers to the intra-LAN 110 representative device preference (S275). It is assumed that in the intra-LAN 110 representative device preference, the device IDs of the device 111 and the device 112 are registered by the communication sequences shown in FIGS. 6 and 7 and the device ID of the device 111 is registered so as to take precedence over the others. That is, the device 111 is selected as the representative device by the terminal control unit 15.

The terminal 121 transmits a connection request to the device 111 (S276). However, the device 111 is turned off, that is, it is not ready for communication, and the terminal 121 cannot receive any response to the connection request. That is, connection is unsuccessful (S277). Here, the terminal 121 refers to the intra-LAN 110 representative device preference, and transmits a connection request to the device 112 registered as a representative device next to the device 111 (S278).

When this connection is successful (S279), after authentication between the terminal 121 and the device 112, the terminal 121 performs the ability check of the device 112 (S280, S281). Although the ability check has been already performed when the device 112 has been registered in the terminal 121, when the device 122 is newly selected as the representative device, the ability check is also performed at the time of the selection.

By this ability check, the terminal 121 checks that the device 112 has the UPnP control point function. By the above, the device 112 is determined as the intra-LAN 110 representative device (S282). That is, the device 112 which is a device within the LAN 110 other than the device 111 that has been previously determined as the representative device is selected as the new representative device.

After the determination of the representative device, in the first embodiment, the device 113 is additionally registered in the intra-LAN 110 device list before a content list batch acquisition request is transmitted from the terminal 121 to the device 112 (S283). The communication sequence in the registration is similar to that shown in FIG. 7.

That is, the terminal 121 transmits a device search request including the device ID of the terminal 121 to the device 112 which is the representative device. The device 113 receives the M-Search request including the device ID of the terminal 121 transmitted from the device 112, checks that the device ID of the terminal 121 is stored in the device ID storing unit 4 of the device 113, and transmits a response including the device ID of the device 113 to the device 112. The device 112 transmits the response to the terminal 121.

Using the device ID of the device 113 included in the received response, the terminal 121 undergoes authentication using a password by the device 113, performs the ability check of the device 113, and registers the device ID of the device 113 in the intra-LAN 110 device list. The terminal 121 also checks that the device 113 has the UPnP control point function, and registers the device ID of the device 113 in the intra-LAN 110 representative device preference (S283).

Then, the terminal 121 transmits the device ID of the terminal 121 and the content list batch acquisition request to the device 112 (S284).

The device 112 having received the content list batch acquisition request transmits a UPnP discovery message (M-Search request) and searches for the devices on the LAN 110. In the first embodiment, the device 111 is turned off, and only the device 113 responds to the M-Search request.

The device 112 transmits the content list batch acquisition request which is a UPnP control message, to the device 113 having made a response (S285). The content list batch acquisition request includes the device ID of the terminal 121.

After checking that the device ID of the terminal 121 included in the content list batch acquisition request from the device 112 is stored in the device ID storing unit 4 of the device 113, the device 113 retrieves all the contents stored in the content storing unit 5 of the device 113, and transmits a content list to the device 112 as the search result (S286).

The device 112 transmits a list of its own contents stored in the content storing unit 5 of the device 112 together with the content list of the device 113 to the terminal 121 (S287).

By the above, the batch search for the contents within the LAN 110 at the terminal 121 is completed (S288). The terminal 121 displays, on the display unit 12 of the terminal 121, the content lists of the device 112 and the device 113 which are a response from the device 112 (S289).

As described above, while the content list has been conventionally acquired by establishing connection with each of the device 112 and the device 113 within the LAN 110, in the communication system of the first embodiment, it is possible to collectively acquire the content lists of plural devices by establishing connection with the device 112 and transmitting the content list batch acquisition request to the device 112. That is, it is possible to reduce the amount of communication, the amount of operation by the user, and the amount of processing by the devices.

Moreover, in the communication system of the first embodiment, when a device is added to the LAN 110 or when a device which has been turned off is turned on, the device responds to the search from the terminal 121 and is additionally registered in the terminal 121 based on the response only when the device itself permits the communication. That is, it is possible to reduce the load imposed on the user because there is no need for the user to perform operations such as checking which device is capable of communication and inputting the device ID of the device.

Moreover, even when the representative device within the LAN 110 becomes incapable of communication, the terminal 121 can select and determine a device that is communication-capable and functions as the representative device from among the devices within the LAN 110 and acquire content lists from all the incapable of communication devices within the LAN 110 through the representative device without any additional operation by the user.

That is, even when one representative device is incapable of communication, since the terminal 121 selects and determine an alternative representative device, the user's request that he/she wants to see the content lists can be satisfied without imposing any load on the user.

As for the connection that the LAN 110 is accessed from the external network 105, the representative device performs authentication and cipher communication using the asymmetric key method or the like and communication within the LAN is performed by simple authentication such as authentication by a password and plaintext communication. By doing this, communication load can be reduced without decreasing the security level on communication from outside the LAN.

A case where connection destinations are plural devices within the LAN is shown in the first embodiment. However, even in the case where connection destinations are devices within the same subnet instead of devices existing within the LAN, no influence is exerted on the operation of each device, and similar effects are acquired.

In addition, the terminal 121 automatically processes the update of the intra-LAN 110 device list shown in the sequence of FIG. 7 after the sequence, shown in FIG. 6, where the terminal 121 registers the device 111. However, the intra-LAN 110 device list may be updated by the user's explicit operation.

Moreover, the user may add a device within the LAN 110 to the intra-LAN 110 device list by operating the terminal 121.

With respect to the representative device preference, in the first embodiment, the device IDs of plural devices, which have been previously connected and which have been proved to have a UPnP control point function as a result of the ability check, are registered together with a predetermined order of priority in the intra-LAN 110 representative device preference. Further, the terminal 121 refers to the intra-LAN 110 representative device preference, and determines the representative device according to the order of priority. However, the representative device may be determined by a different method.

For example, the representative device may be determined by a different method such that 1) the user presets the representative device in the intra-LAN 110 representative device preference, 2) the user arbitrarily selects the representative device from among the registered devices in the representative device determining sequence, and 3) the device IDs of the devices which are candidates for the intra-LAN 110 representative device are stored in all the devices within the LAN 110 and the terminal 121 refers to the device IDs.

As described above, by allowing a user to operate explicitly specific processing, for example, the user is enabled to grasp the condition of the entire communication system.

While the terminal 121 makes the content list batch acquisition request to the devices within the LAN 110 in the first embodiment, it may make a different request. For example, the terminal 121 can acquire the desired contents in the terminal 121 through the representative device within the LAN 110 by transmitting a content acquisition request to the representative device, and the effects of the present invention are not limited to the purpose of acquiring content lists.

Moreover, in the sequence, shown in FIG. 9, at the time when the terminal 121 collectively acquires content lists from devices within the LAN 110 the terminal 121 additionally registers the device 113 which newly becomes incapable of communication after selecting the representative device. However, the timing of the registration of the device which newly becomes incapable of communication may be different.

For example, the operation for the registration may be performed at regular time intervals, or the registration may be performed by the user's operation as described above.

While the device 111, the device 112, and the device 113 provide service in conformity with the UPnP standard, the effects of the present invention are similarly exerted in conformity with any communication standard that realizes searches for devices and contents, and such communication standard is not limited to a specific one.

Further, by defining the request to transmit the device ID of a target device as for the content list batch acquisition request, a specific target device can be selected from the terminal 121.

Moreover, the criterion to judge whether to record a device ID in the intra-LAN representative device preference or not is that the device has the UPnP control point function. However, a different criterion may be used. To sum up, any criterion may be used as long as it can be judged by the criterion that the device has a relay function to acquire information about an other device within the LAN 110 and transmit it to the terminal 121 in response to a request from the terminal 121.

While the method described in Patent Reference 1 is used as the communication method through the NAT router 119 in the first embodiment, any method may be used by which similar effects are obtained like, for example, the STUN technology described in RFC3489, and the present invention is effective even the method described in Patent Reference 1 is not used.

While the terminal 121 does not belong to a LAN through a NAT router, the terminal 121 may belong to a specific LAN, and in that case, similar effects are obtained by using a technology that enables connection through a NAT router such as the method described in Patent Reference 1 and the STUN technology described in RFC3489.

By changing the communication contents, the communication standard, and the communication method to different ones as described above, for example, it becomes possible to design the optimum system that meets the needs of the user when designing a communication system.

### Second Embodiment

### Plural LANs

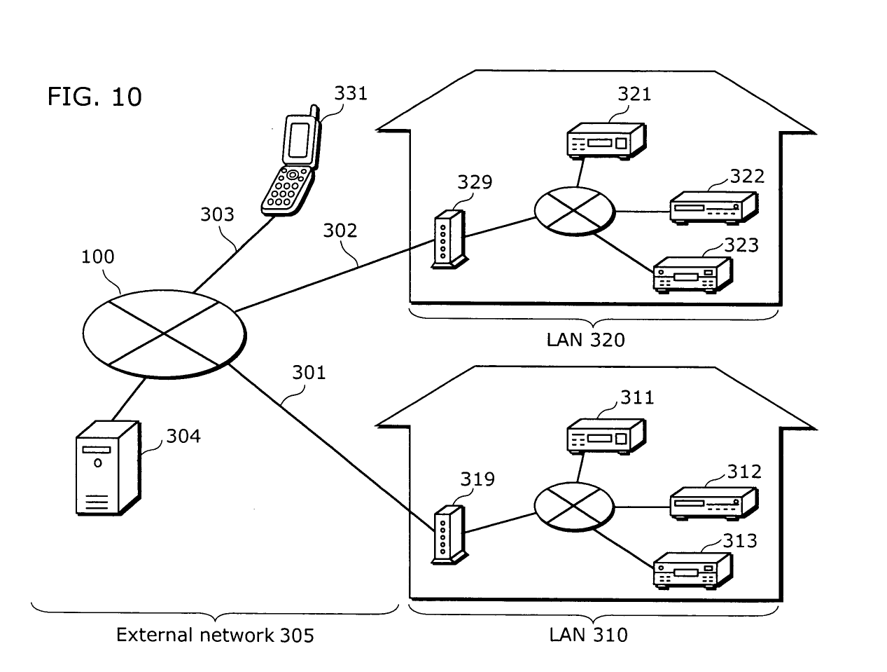

A second embodiment of the present invention will be described using FIGS. 10 to 14.

FIG. 10 is a view showing the structure of a communication system of the second embodiment. Unlike the communication system of the above-described first embodiment, the communication system of the second embodiment is a system in which a terminal existing in an external network performs communication with plural LANs.

As shown in FIG. 10, the communication system of the second embodiment includes an external network 305, a LAN 310, and a LAN 320.

The external network 305 has the Internet 100, a terminal 331, and a NAT passage server 304, and the terminal 331 and the NAT passage server 304 are connected to the Internet 100.

The LAN 310 has a NAT router 319, a device 311, a device 312, and a device 313, and the NAT router 319, the device 311, the device 312, and the device 313 are connected together so as to be capable of communicating with one another. The LAN 310 is connected to the Internet 100 through the NAT router 319.

The LAN 320 has a NAT router 329, a device 321, a device 322, and a device 323, and the NAT router 329, the device 321, the device 322, and the device 323 are connected together so as to be capable of communicating with one another. The LAN 320 is connected to the Internet 100 through the NAT router 329.

The communication channel through which the NAT router 319 and the Internet 100 communicate with each other is referred to as a first communication channel 301, the communication channel through which the NAT router 329 and the Internet 100 communicate with each other is referred to as a second communication channel 302, and the communication channel through which the terminal 331 and the Internet 100 communicate with each other is referred to as a third communication channel 303.

The terminal 331 has the same components and the same function as the terminal 121 in the first embodiment. That is, the terminal 331 has the terminal side communication unit 10, the input unit 11, the display unit 12, the device list storing unit 13, the representative device preference storing unit 14, and the terminal control unit 15. The terminal 331 also has a device ID to identify itself. The terminal 331 is, for example, a mobile telephone.

The device 311, the device 312, the device 313, the device 321, the device 322, and the device 323 have the same components and the same function as the device 111 in the first embodiment. That is, the devices each has the device side communication unit 1, the input unit 2, the display unit 3, the device ID storing unit 4, the content storing unit 5, and the device control unit 6. The devices each stores contents such as moving images, and are, for example, hard disk recorders.

The devices are each a control point defined by the UPnP-DA (device architecture) standard, and has the CDS function of the UPnP-AV standard. The user can register, in these devices, the device ID of a device permitted to be provided with the CDS function for authentication when the CDS function is provided to an other device. The user can also set a password to protect the AV contents provided by the CDS function from being watched by outsiders. The password is held in the device control unit 6, and the device ID is held in the device ID storing unit 4.

The NAT router 329 and the NAT router 319 are routers having the NAT function like the NAT router 119 in the first embodiment, and are router devices that interconvert between global IP addresses and private IP addresses.

The NAT passage server 304 has a similar function to the NAT passage server 103 in the first embodiment. That is, the NAT passage server 304 can establish communication with the devices within the LAN 310 and the devices within the LAN 320 from the terminal 331.

Next, the operation of the communication system of the second embodiment will be described.

Operations described first are: the operation to register the device ID of the terminal 331 in the devices within the LAN 310 and the LAN 320; and the operation to register the device IDs of the devices within the LAN 310 and the LAN 320 in the terminal 331.

In the second embodiment, the power to the device 311, the device 312, the device 313, the device 321, the device 322, and the device 323 is always on.

It is now assumed that the user previously knows the device ID of the terminal 331, the device ID of the device 311, and the device ID of the device 321 and the device ID of the device 311 is already registered in the device 312 and the device 313, that is, the device ID of the device 111 is stored in the device ID storing unit 4 of each device. Likewise, description will be given on the assumption that the device ID of the device 321 is already registered in the device 322 and the device 323, that is, the device ID of the device 321 is stored in the device ID storing unit 4 of each device.

First, in order that the devices within the LAN 310 perform communication with the terminal 331, the device ID of the terminal 331 is registered in the device 311, the device 312, and the device 313. The communication sequence related to this registration is similar to that in the first embodiment, and is performed by an operation similar to that in the communication sequence shown in FIG. 3.

That is, when the device ID of the terminal 331 is inputted from the device 331 by the user, the device 312 and the device 313 check that the device ID of the device 311 is registered in themselves, and store the device ID of the terminal 331 in their device ID storing units 4. The device 311 also stores the device ID of the terminal 331 in its device ID storing unit 4.

The device ID of the terminal 331 is similarly registered in the devices within the LAN 320, and the device ID of the terminal 331 is stored in the device ID storing units 4 of the device 321, the device 322, and the device 323.

Then, the device IDs of the devices within the LAN 310 and the devices with the LAN 320 are registered in the terminal 331. The operation related to this registration is similar to that in the first embodiment, and is performed by an operation similar to that in the communication sequence shown in FIGS. 6 and 7.

That is, when the terminal 331 communicates with the device 311, the device IDs of the device 311, the device 312, and the device 313 and information responding to the ability check are transmitted to the terminal 331 via the device 311. Likewise, when the terminal 331 communicates with the device 321, the device IDs of the device 321, the device 322, and the device 323 and information responding to the ability check are transmitted to the terminal 331 via the device 321.

The devices within the LAN 310 and the LAN 320 respond to requests of the terminal 331 only when the device ID of the terminal 331 is registered in themselves, and permit the registration of their device IDs into the terminal 331 only when passwords that match the passwords assigned to them are transmitted from the terminal 331.

The device IDs of the devices within the LAN 310 transmitted to the terminal 331 are registered in an intra-LAN 310 device list and an intra-LAN 310 representative device preference, and the device IDs of the devices within the LAN 320 are registered in an intra-LAN 320 device list and an intra-LAN 320 representative device preference. In the intra-LAN 310 representative device preference, the device ID of the device 311 is registered as the device having the highest priority as the representative device, and in the intra-LAN 320 representative device preference, the device ID of the device 321 is registered as the device having the highest priority as the representative device.

By the above operation, the intra-LAN 310 device list and the intra-LAN 320 device list are stored in the device list storing unit 13 of the terminal 331, and in the intra-LAN 310 representative device preference and the intra-LAN 320 representative device preference are stored in the representative device preference storing unit 14 of the terminal 331.

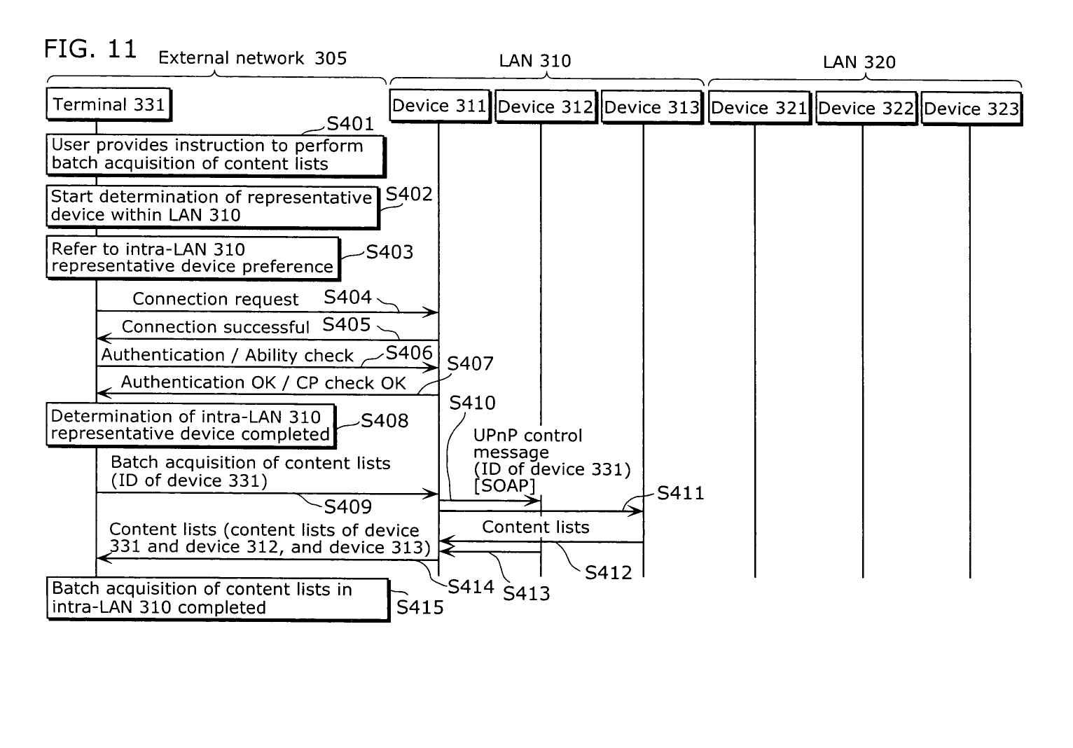

Next, communication sequences when the terminal 331 performs content batch search on the devices within the LAN 310 and the devices within the LAN 320 will be described using FIGS. 11 to 13.

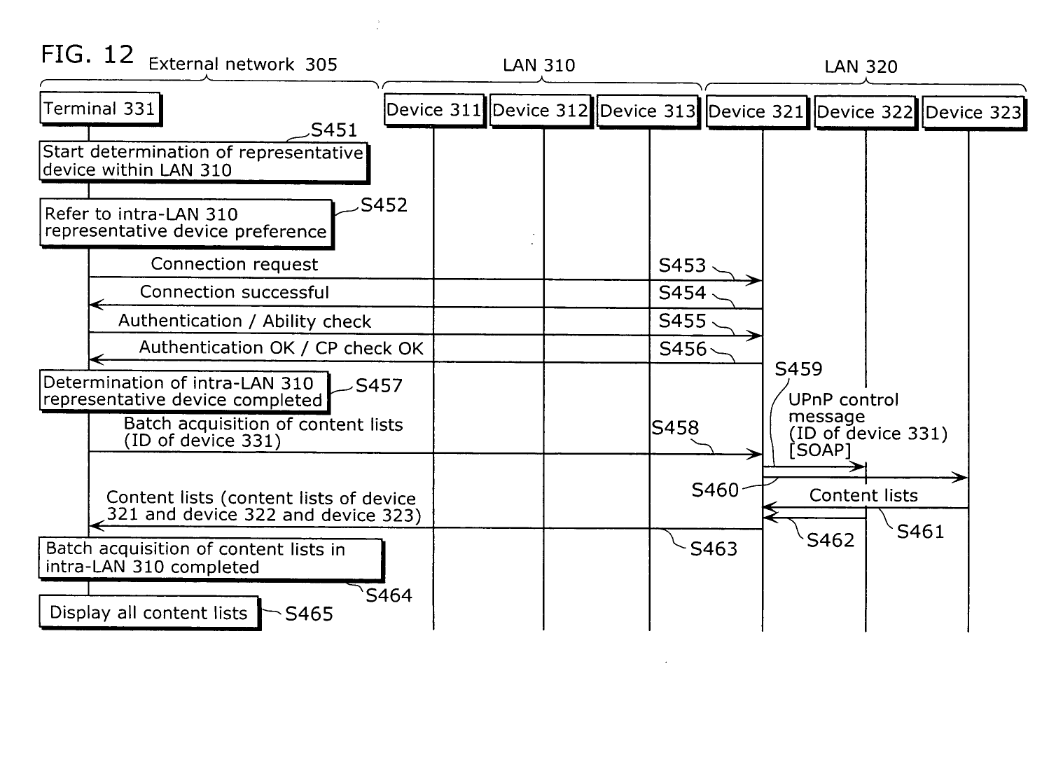

FIG. 11 is a view showing a communication sequence at the time when the user provides an instruction to perform batch acquisition of the content lists of the devices within the LAN 310 from the terminal 331. FIG. 12 is a view showing a communication sequence in the batch acquisition of the content lists of the devices within the LAN 320 performed subsequently to the end of the communication sequence shown in FIG. 11.

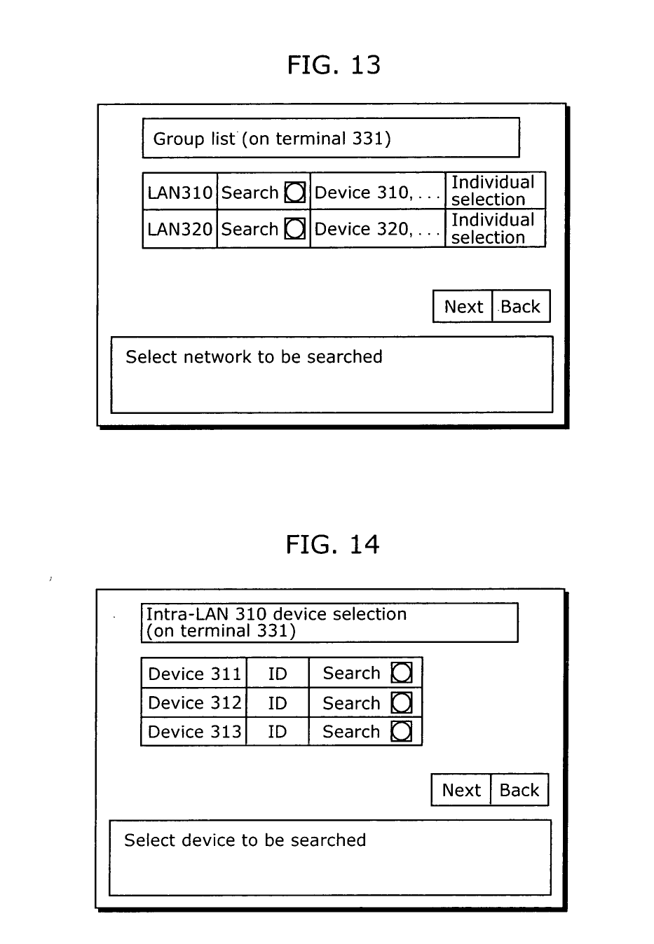

In the terminal 331, a GUI shown in FIG. 13 is displayed on the display 12.

FIG. 13 is a view showing the GUI with which the user selects the LANs to be searched, in order to perform the batch acquisition of the content lists.

In the GUI shown in FIG. 13, the user selects the LAN 310 and the LAN 320 to thereby provide an instruction to perform batch acquisition of the content list in the devices within the LAN 310 and the devices within the LAN 320 (S401).

The terminal 331 having received the instruction starts the determination of the representative device within the LAN 310 (S402). First, the terminal 331 refers to the intra-LAN 310 representative device preference (S403), selects the device 311 as the representative device, and transmits a connection request to the device 311 (S404). When this connection is successful (S405), authentication through a password is performed between the terminal 331 and the device 331 (S405), and then, the ability check is performed (S406, S407). By the above, the device 311 is determined as the intra-LAN 310 representative device (S408).

Then, the terminal 311 transmits the device ID of the terminal 331 and a content list batch acquisition request to the device 311 (S409). The device 311 having received the content list batch acquisition request transmits a UPnP discovery message (M-Search request) and searches for the devices on the LAN 310. Then, the terminal 331 transmits a content list acquisition request which is a UPnP control message to the device 312 and the device 313 having made a response (S410, S411). The content list acquisition request includes the device ID of the terminal 331. After checking that the device ID of the terminal 331 included in the content list acquisition request from the device 311 is stored in their device ID storing units 4, the device 312 and the device 313 retrieve all the contents stored in their content storing units 5, and transmit content lists to the device 311 as the search result (S412, S413). The device 311 transmits its own content list and the content lists of the device 312 together with the device 313 to the terminal 331 through the Internet 100 (S414). By the above, the batch acquisition of the content lists within the LAN 310 at the terminal 331 is finished (S415).

Next, as shown in FIG. 12, the terminal 331 starts the determination of the representative device within the LAN 320 (S451). The terminal 331 refers to the intra-LAN 320 representative device preference (S452), and selects the device 321 as the representative device within the LAN 320.

The follows processing is similar to that of the communication sequence of FIG. 11; the terminal 331 transmits a connection request to the device 321 (S453), and when the connection is successful (S454), performs authentication and the ability check (S455, S456). By the above, the device 321 is selected as the representative device within the LAN 320 (S457).

Next, the terminal 311 transmits the device ID of the terminal 331 and a content list batch acquisition request to the device 321 (S458). The device 321 having received the content list batch acquisition request transmits a UPnP discovery message (M-Search request) and searches for the devices on the LAN 320. Then, the terminal 331 transmits a content list acquisition request to the device 322 and the device 323 having made a response (S459, S460).

The device 322 and the device 323 check that the device ID of the terminal 331 included in the content list acquisition request from the device 321 is stored in their device ID storing units 4, retrieve all the contents stored in their content storing units 5, and transmit content lists to the device 321 as the search result (S461, S462).

The device 321 transmits its own content list and the content lists of the device 322 together with the device 323 to the terminal 331 through the Internet (S463).

By the above, the batch search of the contents within the LAN 310 at the terminal 331 is finished (S464).

By the above, the terminal 331 displays, on the display unit 12, the content lists of the devices within the LAN 310 together with the content lists of the devices within the LAN 320 (S465).

As described above, in the communication system of the second embodiment, the terminal 331 holds the intra-LAN device list and the intra-LAN representative device preference of each LAN, in the device list storing unit 13 and the representative device preference storing unit 14. Thereby, when connection is established with plural LANs, it is possible to transmit a request to each LAN and collectively request all the devices existing within the plural LANs to perform batch processing.

Moreover, the communication system of the second embodiment has the functions of the terminal and the devices included in the communication system of the first embodiment as they are. For this reason, the effects such as the reduction in the amount of communication and the amount of operation by the user mentioned in the description of the communication system of the first embodiment are exerted as they are in the communication system of the second embodiment. Moreover, like the communication system of the first embodiment, it is possible to allow the user to operate explicitly specific processing and to change the communication contents, the communication standard, and the communication method to the above-described ones.

While a case is described where the content list batch acquisition request is transmitted to the devices within the LAN 310 and the LAN 320, the content list acquisition request may be selectively made to individual devices.

For example, a GUI as shown in FIG. 14 is displayed when the “individual selection” is selected by the user on the GUI shown in FIG. 13 which is a GUI allowing the user to select the LAN to be searched. As shown in FIG. 14, the user is enabled to individually select a device within a specific LAN as the object to be searched for, and a request to transmit the device ID of the device selected by the user is defined, whereby the content list existing in a specific device can be acquired from the terminal 331.

By doing this, in a case where the user has previously determined the device from which the content list is acquired, the content list desired by the user can be acquired with a minimum amount of communication.

### Third Embodiment

### Cache Service is Present

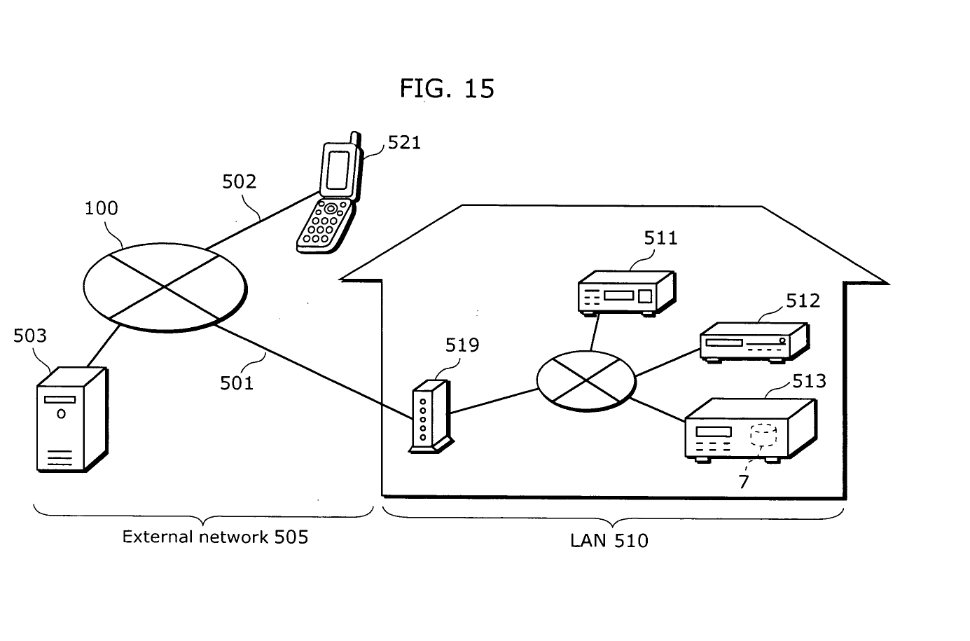

A third embodiment of the present invention will be described using FIGS. 15 to 18.

FIG. 15 is a view showing the structure of a communication system of the third embodiment. The communication system of the third embodiment is a system in which a terminal existing in an external network and the devices within one LAN perform communication like the communication system of the first embodiment. However, unlike the first embodiment, the communication system of the third embodiment uses a cache function of a device within the LAN.

As shown in FIG. 15, the communication system of the third embodiment includes an external network 505 and a LAN 510.

The external network 505 has the Internet 100, a terminal 521, and a NAT passage server 503, and the terminal 521 and the NAT passage server 503 are connected to the Internet 100.

The LAN 510 has a NAT router 519, a device 511, a device 512, and a device 513. The NAT router 519, the device 511, the device 512, and the device 513 are connected together so as to be capable of communicating with one another. The LAN 510 is connected to the Internet 100 through the NAT router 519.

The communication channel through which the NAT router 519 and the Internet 100 communicate with each other is referred to as a first communication channel 501, and the communication channel through which the terminal 521 and the Internal 100 communicate with each other is referred to as a second communication channel 502.

The terminal 521 has the same components and the same function as those of the terminal 121 in the first embodiment. That is, the terminal 521 has the terminal side communication unit 10, the input unit 11, the display unit 12, the device list storing unit 13, the representative device preference storing unit 14, and the terminal control unit 15. The terminal 521 also has a device ID to identify the terminal 521. The terminal 521 is, for example, a mobile telephone.

The device 511 and the device 512 have the same components and the same function as the device 111 in the first embodiment. That is, the devices each has the device side communication unit 1, the input unit 2, the display unit 3, the device ID storing unit 4, the content storing unit 5, and the device control unit 6.

The device 513 has a cache storing unit for caching information, in addition to the same components as those of the device 111 in the first embodiment.

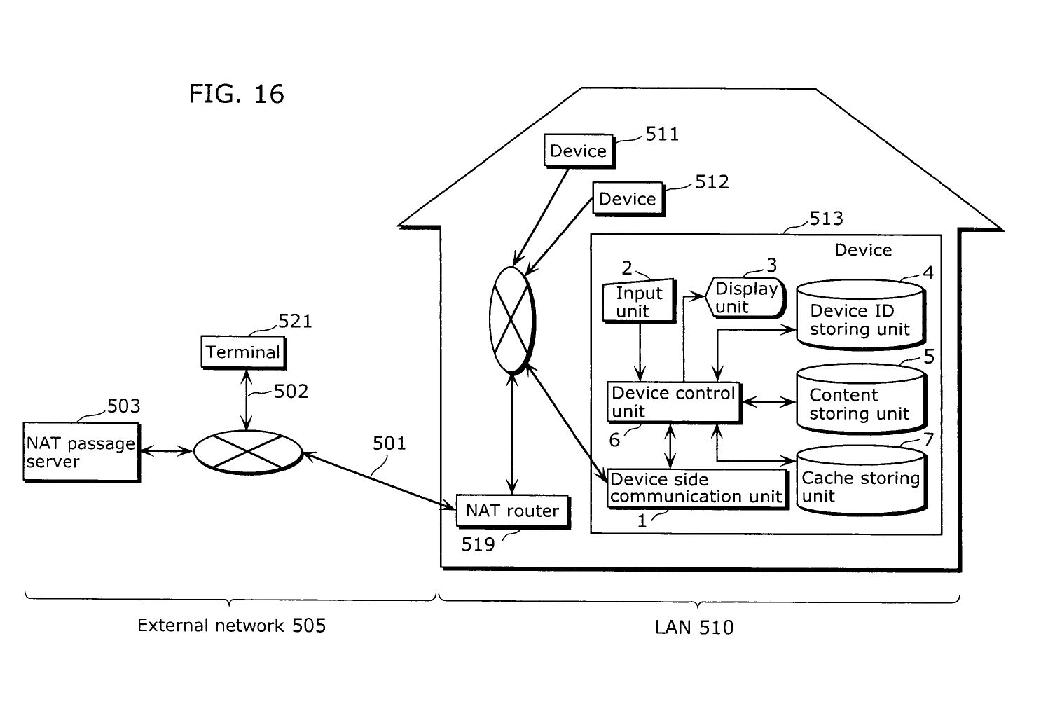

FIG. 16 is a functional block diagram showing the functional structure of the device 513 in the communication system of the third embodiment.

As shown in FIG. 16, the device 513 has the device side communication unit 1, the input unit 2, the display unit 3, the device ID storing unit 4, the content storing unit 5, and the device control unit 6 which are the same components as those of the device 111 in the first embodiment, and further has the cache storing unit 7.

The device 513 has the function as a UPnP control point like the device 111 in the first embodiment, and further has the cache function. The cache function referred to here is the function of: transmitting, at regular time intervals, requests for device search, device setting check, and content list acquisition to all the devices within the same LAN; and holding responses thereto as internal data.

The cache storing unit 7 is an example of the device information storing unit in the communication device of the present invention, and is a storage device for storing information transmitted from the devices within the LAN 510 as a response by the above-mentioned cache function. “To cache” in the following description means to acquire information about the devices within the LAN 510 and store, and hold the information in the cache storing unit 7. The processing related to caching is performed by the device control unit 6 like other processings.

The device 511, the device 512, and the device 513 have contents such as moving images like the device 111 in the first embodiment, and are, for example, hard disk recorders. These devices are each a control point defined by the UPnP-DA (device architecture) standard, and have the CDS function of the UPnP-AV standard. The devices each has a device ID to identify themselves, and the user can register, in these device, the device ID of a device permitted to be provided with the CDS function so that the device is authenticated at the time when the CDS function is provided to the device. The user can also set a password to protect the AV contents provided by the CDS function from being watched by outsiders. The password is held in the device control unit 6, and the device ID is held in the device ID storing unit 4.

The NAT router 519 is a router having the NAT function like the NAT router 119 in the first embodiment, and is a router device that interconverts between global IP addresses and private IP addresses.

The NAT passage server 503 has a function similar to the NAT passage server 103 in the first embodiment. That is, the NAT passage server 503 can establish communication from the terminal 331 to the devices within the LAN 510.

Next, the operation of the communication system of the third embodiment will be described.

The operations described first are: the operation to register the device ID of the terminal 521 in the devices within the LAN 510; and the operation to register the device IDs of the devices within the LAN 510 in the terminal 521.

In the third embodiment, power to the device 511, the device 512, and the device 513 is always on.

Hereinafter, description will be given on the assumption that the user previously knows the device ID of the terminal 521 and the device ID of the device 511, and the device ID of the device 511 is registered in the device 512 and the device 513, that is, the device ID of the device 511 is stored in the device ID storing unit 4 of each device.

First, in order that the devices within the LAN 501 perform communication with the terminal 521, the device ID of the terminal 521 is registered in the device 511, the device 512, and the device 513. The communication sequence related to this registration is similar to that of the first embodiment, and is performed by an operation similar to that of the communication sequence shown in FIG. 3.

That is, when the device ID of the terminal 521 is inputted from the device 511 by the user, the device 512 and the device 513 check that the device ID of the device 511 is registered in themselves. After the check, the device 512 and the device 513 store the device ID of the terminal 521 in their device ID storing units 4. The device 511 also stores the device ID of the terminal 521 in its device ID storing unit 4.

Next, the device IDs of the devices within the LAN 510 are registered in the terminal 521. The operation related to this registration is similar to that of the first embodiment, and is performed by an operation similar to that of the communication sequence shown in FIG. 6.

That is, when the terminal 521 communicates with the device 511, the device IDs of the device 511, the device 512, and the device 513 and information responding to the ability check are transmitted to the terminal 521 via the device 511.

The devices within the LAN 510 respond to requests of the terminal 521 only when the device ID of the terminal 521 is registered in themselves, and permit the registration of their device IDs in the terminal 521 only when passwords that match the passwords assigned to them are transmitted from the terminal 521.

The device IDs of the devices within the LAN 510 transmitted to the terminal 521 are registered in an intra-LAN 510 device list and an intra-LAN 510 representative device preference.

The device 513 has the cache function as mentioned above. For this reason, the device 513 makes a response indicating that it has the caching function, as the response to the ability check from the terminal 521, or directly, as the response to the UPnP description acquisition of the device 511.

The terminal 521 receives this response via the device 511. Thereby, the terminal 521 checks that the cache function is operating in the device 513, and registers the device 513 in the intra-LAN 510 representative device preference as the device having the highest priority as the representative device. Thereby, the terminal 521 can automatically establish connection with the device 513 having the cache function when transmitting a batch request to the devices within the LAN 510.

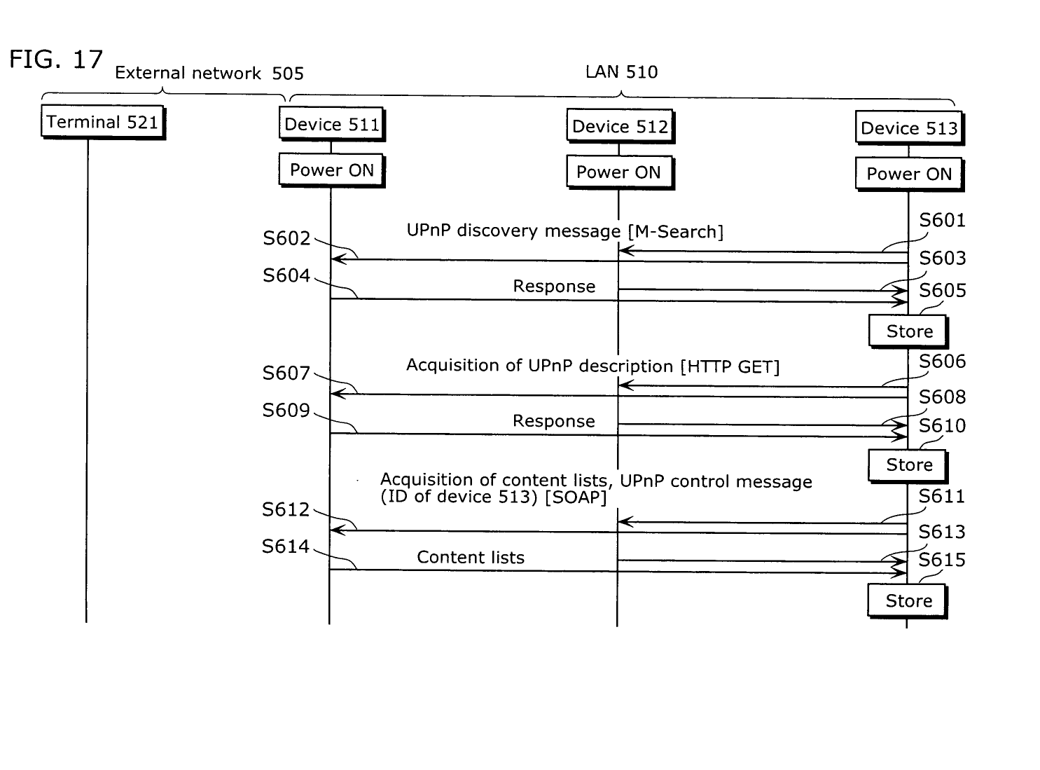

FIG. 17 is a view showing a communication sequence of communication by the cache function of the device 513. The operation of the device 513 that is performed when acquiring information from the device 511 and the device 512 within the LAN 510 and storing it in the cache storing unit will be described with reference to FIG. 17. This operation related to cache is performed once an hour in the third embodiment.

The device 513 transmits an M-Search request which is a UPnP discovery message to the device 511 and the device 512 on the LAN 510 (S601, S602).

The device 511 and the device 512 transmit a response to the M-Search request to the device 513 (S603, S604). By receiving the response, the device 513 checks the communication condition of the devices within the LAN 510, that is, whether communication is possible or not, and stores it in the cache storing unit 7 as internal data (S605).

Next, on the LAN 510, the device 513 makes a request for the acquisition of the UPnP description (S606, S607), and receives responses thereto from the device 511 and the device 512 (S608, S609). From these responses, the device 513 checks the device setting of the device 511 and the device 512, and stores it in the cache storing unit 7 as internal data (S610).

Next, on the LAN 510, the device 513 transmits a content list acquisition request which is a UPnP control message (S611, S612). As responses thereto, the device 513 receives the content list of the device 512 and the content list of the device 511 (S613, S614). Further, the device 513 collectively stores the received content lists of the device 512 and the device 511 into the cache storing unit 7 as internal data (S615).

As described above, when the device 513 caches the information held by the devices existing within the LAN 510, the terminal 521 can more quickly acquire the information held by the devices existing within the LAN 510.

As an example of the case where the terminal 521 acquires the information held by the devices within the LAN 510, the operation of the terminal 521 performed when collectively acquiring content lists from the devices within the LAN 510 will be described.

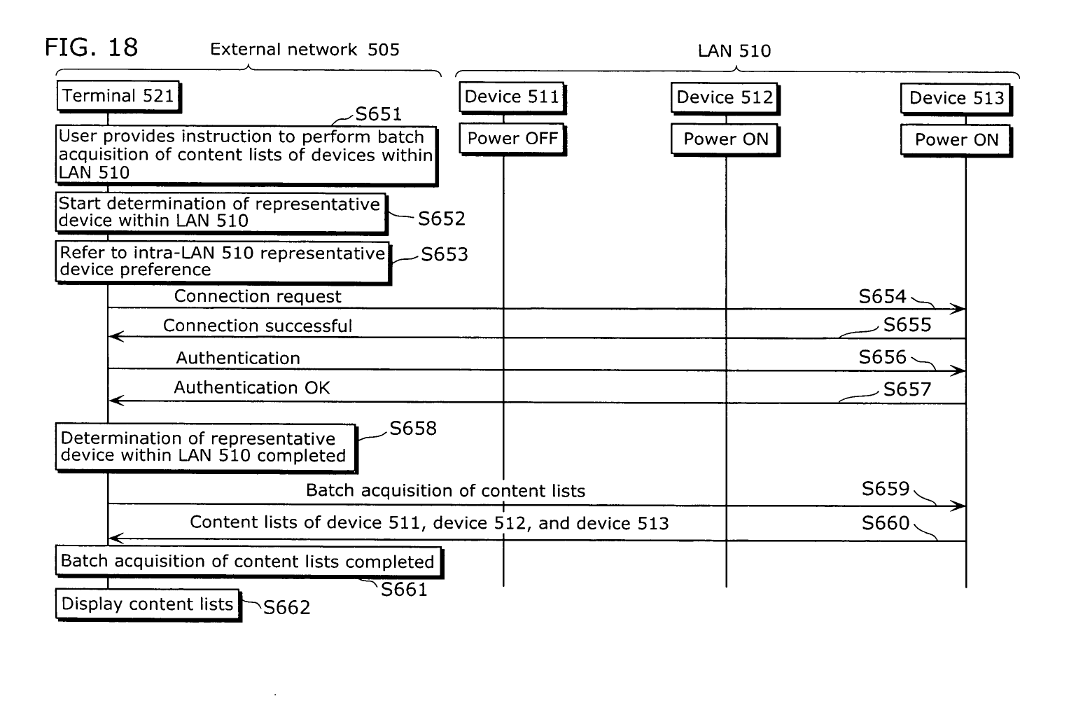

FIG. 18 is a view showing a communication sequence at the time when the user provides an instruction to perform batch acquisition of the content lists of the devices within the LAN 510 from the terminal 521.

At the terminal 521, the user provides an instruction to perform batch search for contents (S651).

The terminal 521 having received the instruction starts the determination of the representative device within the LAN 510 (S652). First, the terminal 521 refers to the intra-LAN 510 representative device preference (S653). In the intra-LAN 510 representative device preference, as mentioned above, the device ID of the device 513 is registered as the device 513 having the highest priority, that is the representative device, and the terminal 521 selects the device 513 as the representative device.

The terminal 521 transmits a connection request to the device 513 (S654). When the device 513 returns a response indicating that connection is successful (S655), the terminal 521 requires the device 513 of authentication by a password (S656), and is authenticated (S657). By the above, the selection of the representative device within the LAN 510 is completed (S658).

Next, the terminal 521 transmits a content list batch acquisition request to the device 513 (S659). As mentioned above, by the cache function, the device 513 stores the content lists of the device 511, the device 512, and the device 513 in the cache storing unit 7. Therefore, the device 513 selects the content lists of the device 511, the device 512, and the device 513 which is the information corresponding to the request, from the cache storing unit 7, and transmits them to the terminal 521 (S660).

By the above-described operation, the batch acquisition of the content lists of the devices within the LAN 510 performed by the terminal 521 is completed (S661).

The terminal 521 displays the acquired content lists on the display unit 12 (S662).

As described above, according to the third embodiment, when the device with the cache function manages and caches the information held by the devices existing within the LAN 510, the terminal 521 can quickly acquire the information held by the devices existing within the LAN 510.

Moreover, the communication system of the third embodiment has the functions of the terminal and the devices included in the communication system of the first embodiment as they are. For this reason, the effects such as the reduction in the amount of communication and the amount of operation by the user mentioned in the description of the communication system of the first embodiment are exerted as they are in the communication system of the third embodiment. Moreover, like the communication system of the first embodiment, it is possible to allow the user operate explicitly specific processing and change the communication contents, the communication standard, and the communication method to the above-described ones.

While in the third embodiment, with respect to the cache function of the device 513, requests for device search, device setting check, and content list acquisition are transmitted to all the devices within the same LAN at regular time intervals and the responses thereto are cached, the contents of the cache are not limited thereto.

For example, an item that can be outputted by a function of the device itself may be cached, such item may be the remaining space of the content storing unit of the device and the internal temperature of the device.

The timing of caching, that is, the timing of transmitting the content list acquisition request is once an hour in the third embodiment, but the timing is not limited to once an hour.

For example, in the case where the contents of each device is almost unchanged, the timing may be once a week. Conversely, when the contents are frequently changed, the timing may be once every ten minutes.

Moreover, the timing of caching is not limited to at regular time intervals; the contents of the cache can be efficiently kept up to date, for example, by performing caching in response to an event notification from an other device.

Generally, when such an event notification is used, it is known that a small amount of communication steadily occurs for the event although the content search time is reduced, and it is difficult to apply this to a communication with the outside of the LAN in which a load such as authentication occurs when communication is started. On the contrary, according to the present embodiment, since the update of the cache can be limited to within the LAN, the search time can be reduced without letting a steady load to occur outside the LAN.

As described above, a communication system highly convenient to the user can be constructed by changing the contents to be cashed, caching timing, and the like.

Moreover, in the third embodiment, when the device 513 becomes incapable of communication, the terminal 521 tries to establish connection with the device 511 or the device 512 registered in the intra-LAN 510 representative device preference. However, as mentioned above, the communication system of the third embodiment has the functions of the terminal and the devices included in the communication system of the first embodiment as they are. For this reason, even when a device not having the cache function becomes the representative device, similar effects as those of the communication system of the first embodiment are obtained.

While the cache function is present only in the device 513 in the third embodiment, plural devices having the cache function may be present within the same LAN. By doing this, for example, even when the device 513 becomes incapable of communication, the terminal 521 can acquire the information cached by an other device.

While in the third embodiment, the device 513 having the cache function is selected as the representative device within the LAN 510 with the highest priority, a device not having the cache function may be preferentially selected as the representative device.

By doing this, the devices within the LAN 510 are frequently changed, and thus when not cached information but real-time information is desired, for example, content lists at the time when a content search request is made from the terminal 521 are desired, a communication system highly convenient to the user is obtained.

### Fourth Embodiment

### Reproduction of Encrypted Contents at the Terminal

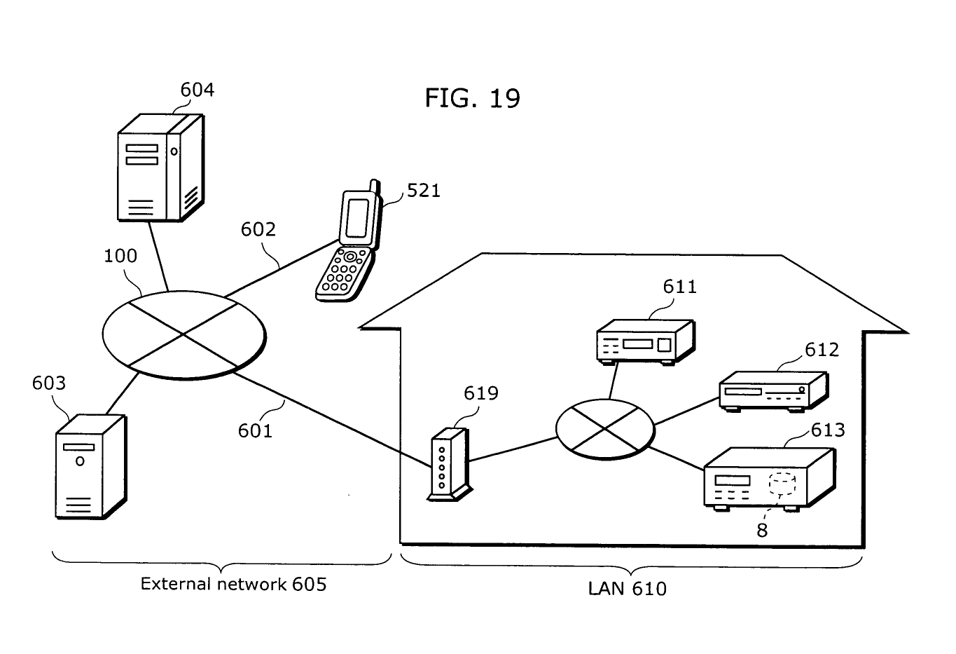

A fourth embodiment of the present embodiment will be described using FIGS. 19 to 22.

FIG. 19 is a view showing the structure of a communication system of the fourth embodiment. Like the communication system of the above-described first embodiment, the communication system of the fourth embodiment is a system in which a terminal existing in an external network and the devices within one LAN communicate with each other, and further, a content server 604 is connected to the Internet 100.

The content server 604 provides contents such as moving images and sounds to devices connected to the Internet.

In the communication system of the present embodiment, the devices within the LAN are capable of downloading contents such as moving images from the content server 604, and are capable of reproducing the contents on the terminal existing in an external network.

As shown in FIG. 19, the communication system of the fourth embodiment includes an external network 605 and a LAN 610.

The external network 605 has the Internet 100, a terminal 621, a NAT passage server 603, and the content server 604, and the terminal 621, the NAT passage server 603, and the content server 604 are connected to the Internet 100.

The LAN 610 has a NAT router 619, a device 611, a device 612, and a device 613, and the NAT router 619, the device 611, the device 612, and the device 613 are connected together so as to be capable of communicating with one another. The LAN 610 is connected to the Internet 100 through the NAT router 619.

The communication channel through which the NAT router 619 and the Internet 100 communicate with each other is referred to as a first communication channel 601, and the communication channel through which the terminal 621 and the Internal 100 communicate with each other is referred to as a second communication channel 602.

The terminal 621 is a device for performing communication with the devices within the LAN 610 and is capable of storing contents such as moving images. For example, it is implemented as a mobile telephone.

The device 611, the device 612, and the device 613 are devices capable of downloading contents such as moving images from the content server 604 through the Internet 100, and are, for example, hard disk recorders.

The contents provided by the content server 604 are made unreproducible by encryption or the like, and when the contents are downloaded, license keys which are information necessary for reproducing the contents are downloaded as well. The license keys are an example of the reproduction key in the communication device of the present invention.

These devices within the LAN 610 have a license key storing unit 8 for storing the license keys and the device ID of the terminal so as to be associated with each other in addition to the same components as those of the device 111 of the first embodiment. The license key storing unit 8 is an example of the reproduction key storing unit in the communication device of the present invention.

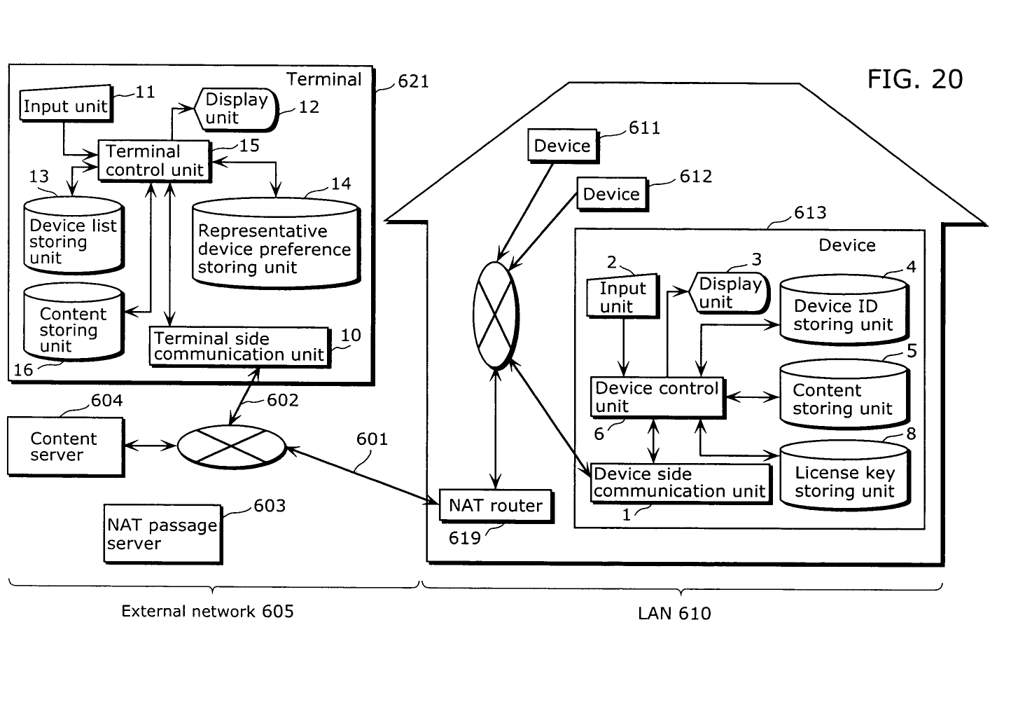

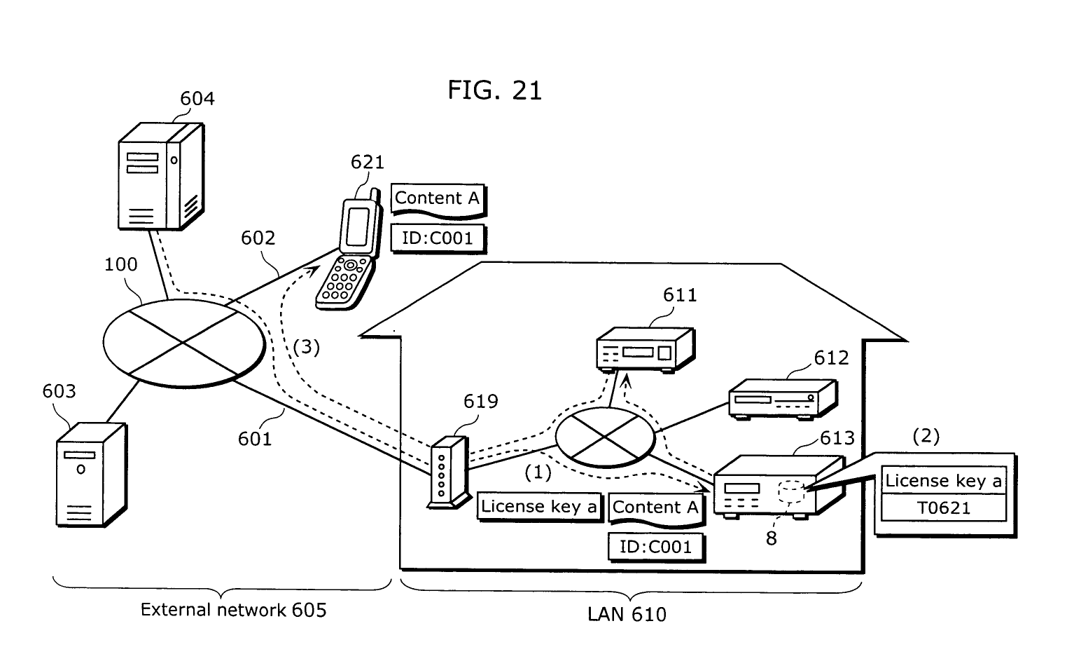

FIG. 20 is a functional block diagram showing the functional structure of the device 613 in the communication system of the fourth embodiment. The functional structures of the device 611 and the device 612 are similar to the device 613.

As shown in FIG. 20, the device 613 has the device side communication unit 1, the input unit 2, the display unit 3, the device ID storing unit 4, the content storing unit 5, and the device control unit 6 which are the same components as those of the device 111 in the first embodiment, and further has the license key storing unit 8.

The content storing unit 5 stores contents downloaded from the content server 604. The license keys downloaded together with the contents are stored in the license key storing unit 8 so as to be associated with the device ID of the terminal permitted to reproduce the contents.

The contents and the license keys corresponding to the contents can be uniquely identified by content IDs.

The terminal 621 has the terminal side communication unit 10, the input unit 11, the display unit 12, the device list storing unit 13, the representative device preference storing unit 14, and the terminal control unit 15 which are the same components as those of the terminal 121 of the first embodiment, and further has a content storing unit 16.

Moreover, the terminal 621 can acquire contents from the device 613 by an operation similar to the operation, described using FIG. 9, to acquire the content lists of the devices within the LAN.

However, the contents downloaded from the content server 604 are encrypted as mentioned above, and the license keys corresponding to the contents are necessary to reproduce them on the terminal 621.

In the present embodiment, when a request to acquire a license key is made by the terminal 621, the device 613 checks whether the license key is stored in the license key storing unit 8 so as to be associated with the device ID of the terminal 621 or not. Then, only when the license key is stored so as to be associated with the device ID of the terminal 621, the device 613 transmits the license key to the representative device, and the representative device transmits the license key to the terminal 621.

That is, in the communication system of the present embodiment, only the terminal permitted to reproduce a content can acquire the license key corresponding to the content.

Other functions of the device 611, the device 612, and the device 613 are similar to those of the device 111 in the first embodiment, and have the function as a control point, the CDS function of the UPnP-AV, and the like.

The NAT router 619 is a router having the NAT function like the NAT router 119 in the first embodiment, and is a router device that intercoverts between global IP addresses and private IP addresses.

The NAT passage server 603 has a similar function to the NAT passage server 103 in the first embodiment. That is, it is capable of establishing communication with the devices within the LAN 610 from the terminal 621.

As mentioned above, for the reproduction of contents, the corresponding license keys are necessary. However, in many cases, various limits in use such as the valid term are imposed on license keys from the viewpoint of copyright protection. Therefore, in the present embodiment, it is assumed that for the license keys, the valid term from when they are stored is set.

For example, when the valid term of a license key is set to 24 hours, the content corresponding to the license key can be reproduced as long as it is within 24 hours from when the license key is downloaded and stored by the device 613. The same applies when a license key is copied in the terminal 621, and the license key is valid for 24 hours from when it is stored in the terminal 621.

Next, the operation of the communication system of the fourth embodiment will be described.

The terminal 621 can acquire a content and its license key at the same time from the device 613. However, contents such as moving images are large in capacity, and it is considered that it takes time to transmit them from the device 613 to the terminal 621. Moreover, the valid term is set for license keys as mentioned above.

For this reason, the user can surely reproduce the content by causing the terminal 621 to acquire a content when there is enough time to do so and acquiring the license key when reproducing the content later, for example, at a place away from home.

Therefore, in the following description, the operation of each device and the information flow will be described for each of the cases where the terminal 621 acquires a content and where it acquires its license key.

First, the operation of each device at the time when a content is downloaded from the content server 604 to the device 613 and acquired by the terminal 621 will be described using FIG. 21.

FIG. 21 is a view showing the information flow at the time when a content downloaded from the content server 604 to the device 613 is acquired by the terminal 621 in the communication system of the fourth embodiment. The broken arrows in the figure express the information flow.

In the communication system shown in FIG. 21, the registration of the devices ID of the terminal 621 in the devices within the LAN 610 such as the device 613 is already completed by a communication sequence similar to that shown in FIG. 3. That is, the terminal 621 is in a condition where it can acquire information from the devices within the LAN 610.

It is assumed that the device 611 is selected as the representative device by the terminal 621. That is, the device 613 exchanges information with the terminal 621 through the device 611.

Moreover, it is assumed that the content downloaded from the content server 604 to the device 613 is a content A and the content ID which is the identifier of the content A and the license key are “C001” and a license key a, respectively. Moreover, description will be given on the assumption that the device ID of the terminal 621 is “T0621”.

Now, the information flow and the operation corresponding to (1) to (3) shown in FIG. 21 will be described in order.

(1) By the user's operation, the content A, the content ID “C001”, and the license key a are downloaded from the content server 604 to the device 613.

(2) The content A and the content ID “C001” are stored in the content storing unit 5 so as to be associated with each other, and the license key a is stored in the license key storing unit 8. The device ID “T0621” of the terminal 621 is inputted by the user, and “T0621” is stored in the license key storing unit 8 so as to be associated with the license key a. That is, the terminal 621 is registered in the device 613 as the terminal permitted to reproduce the content A.

(3) Considering watching the contents A while away from home, the user causes the terminal 621 to acquire the content A. Specifically, the terminal 621 acquires the content list of the device 613 by the same communication sequence as the above-described communication sequence shown in FIG. 9. The terminal 621 selects the content A from the content list, and acquires the content A and the content ID “C001” through the device 611 which is the representative device. The terminal 621 stores the obtained content A and content ID “C001” in the content storing unit 16.

By the above operation and information flow shown in (1) to (3), the terminal 621 can acquire the content A and the content ID “C001”.

In the above-described operation and information flow shown in (2), the device ID “T0621” of the terminal 621 is not necessarily inputted by the user. For example, the device ID “T0621” is previously stored in the device ID storing unit 4. Thereafter, the device ID “T0621” is read from the device ID storing unit 4 automatically or by an explicit instruction from the user and stored in the license key storing unit 8 so as to be associated with the license key a at the time when the license key a is stored in the license key storing unit 8.

Moreover, for example, the device IDs of plural terminals are stored in the device ID storing unit 4. Thereafter, the user selects one or more device IDs to be associated with the license key a at the time when the license key a is stored in the license key storing unit 8. Further, the selected one or more device IDs of terminals may be stored in the license key storing unit 8 so as to be associated with the license key a.

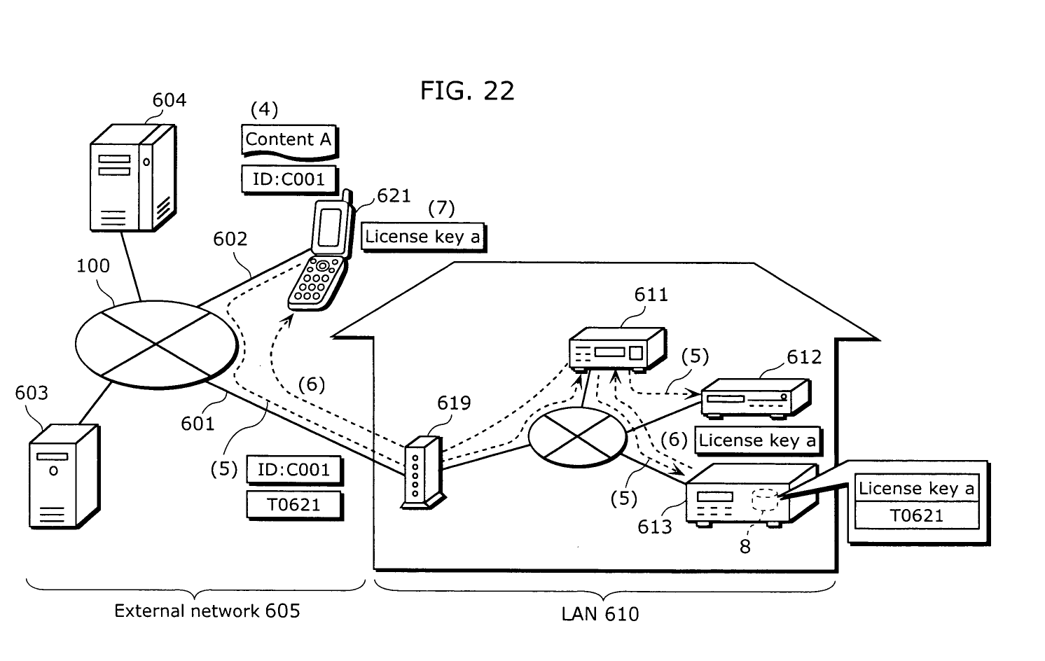

Next, the operation of each device from when the terminal 621 makes a request for a license key to when it acquires the license key will be described using FIG. 22.

FIG. 22 is a view showing the flow of information at the time when the terminal 621 acquires the license key of the content to be reproduced in the communication system of the fourth embodiment. The broken lines in the figure express the information flow.

Now, the information flow and the operation corresponding to (4) to (7) shown in FIG. 22 will be described in order.

(4) The terminal 621 accepts an instruction to start the reproduction of the content A stored in the content storing unit 16 from the user.

(5) Accepting the instruction, the terminal 621 transmits a license key request to the device 611 as a request for information about the devices within the LAN 610. Specifically, the terminal 621 generates a license key request including the device ID “T0621” of the terminal 621 and the content ID “C001” which is the identifier of the content A, and transmits it to the device 611 which is the representative device of the LAN 610. This license key request is generated by the terminal control unit 15, and transmitted by the terminal side communication unit 10.

The device 611 receives the license key request, and transmits an inquiry message including “T0621” and “C001” to the device 612 and the device 613.

(6) The device 613 receives the inquiry message, and checks whether the license key a corresponding to the content ID “C001” is stored in the license key storing unit 8 so as to be associated with “T0621” or not. This check is performed by the device control unit 6.

In the present embodiment, the license key a and “T0621” are stored so as to be associated with each other in the license key storing unit 8 of the device 613, and the license key a is transmitted to the device 611 which is the representative device, as the response to the inquiry message. The device 611 receives the license key a, and transmits it to the terminal 621.

Although the above check is performed also in the device 611 and the device 612, since the license key a is not stored or not associated with “T0621”, the operation associated with the license key request from the terminal 621 is finished.

(7) The terminal 621 acquires the license key a necessary for reproducing the content A from the device 611, and reproduces the content A. Thereafter, when the valid term set for the license key a expires, the content A becomes unreproducible at the terminal 621.

By the above operation and information flow shown in (4) to (7), the terminal 621 can acquire the license key and reproduce the content A.

As described above, in the communication system of the fourth embodiment, contents of the devices within the LAN 610 and the license keys necessary for reproducing the contents can be acquired from a terminal outside the LAN 610.

Moreover, at the time of the acquisition, it is unnecessary for the terminal 621 to check which device has the desired content on a device-by-device basis, and the terminal 621 can collectively acquire lists of the contents existing in the devices within the LAN 610 from the representative device.

Moreover, when the license key is acquired, it is unnecessary to be conscious of which device has the license key that needs to be acquired, and it is only necessary to transmit the license key request including the device ID of the terminal 621 and the content ID to the representative device.

The devices within the LAN such as the device 613 receive the content ID and the device ID of the terminal 621 through the representative device, and check whether the license key corresponding to the content ID is stored so as to be associated with the device ID or not.

That is, authentication is performed as to whether the terminal 621 requiring the license key is a terminal permitted to reproduce the content corresponding to the license key. When the terminal 621 is authenticated, the license key is transmitted to the representative device. The representative device transmits the license key transmitted from the device 613 within the LAN 610, to the terminal.

As described above, without checking whether a desired content is present or not for each device within the LAN 610, the terminal 621 can obtain the content. In addition, the terminal 621 can acquire the license key necessary for the content in a similar manner.

That is, in the communication system of the present embodiment, when the user watches a content of each of plural devices within a LAN, on a terminal outside the LAN, the amount of communication required for the watching and the load associated with the user's operation can be reduced.

The terminal 621 acquires the content A from the device 613 through the device 611 which is the representative device. However, the content A may be acquired by different means. For example, the content A may be acquired via a storage medium such as a CD-ROM. Moreover, the content A may be directly acquired from the device 613 within the LAN 610 by connecting the terminal 621 directly to the LAN 610. Moreover, the content A may be acquired by downloading only the content A from the content server 604.

In the above-described first to fourth embodiments, the terminal device such as the terminal 121 that performs communication with the devices within the LAN is a mobile telephone. However, it may be a device other than a mobile telephone. For example, it may be a mobile terminal such as a PDA (personal digital assistance) or a personal computer.

That is, the terminal device such as the terminal 121 can be implemented as any device that has the communication function and the function of storing device lists and the like which the terminal 121 have.

In the above-described embodiments, the devices within the LAN such as the device 111 are hard disk recorders. However, they may be devices other than hard disk recorders, and may be home electric appliances, personal computers, or the like having the communication function.

That is, the devices within the LAN such as the device 111 can be implemented as any devices that have the communication function and the function of managing the information to be transmitted to the terminal which the device 111 have.

As described above, by using the terminal and the devices constituting the communication system in various combinations, for example, it becomes possible to realize a design which optimizes the balance between the convenience of the user and the cost required to the construction of the communication system.

### INDUSTRIAL APPLICABILITY

The present invention can provide communication between one device and plural devices connected through the Internet, inexpensively irrespective of the band, so as to respond to changes in the condition of the target of communication as much as possible, and safely in communication security. This enables the present invention to be widely applied to the provision of network applications for individual use such as grasping the condition of plural AV devices existing in the home from a place away from home and enjoying a desired content at the place away from home by establishing connection only once.

In addition, the present invention is applicable not only to communication systems for individual use but also to, for example, communication systems for a salesperson to acquire sales information stored in plural servers in the office, from a place away from the office and use the information for sales activities.

1-25. (canceled)

26. A communication system comprising: a terminal device; and a plurality of communication devices existing within a LAN connected to said terminal device through the Internet,
wherein said terminal device includes:
an intra-LAN information storing unit operable to store information about processing performed by said plurality of communication devices;
a determining unit operable to determine one representative device which is a communication device that serves as a representative, from among said plurality of communication devices based on the information stored in said intra-LAN information storing unit;
a request transmitting unit operable to transmit a request for information about said communication device within the LAN, to said representative device determined by said determining unit; and
a response receiving unit operable to receive a response to the request from said representative device, and
said communication device includes:
a request receiving unit operable to receive a request for the information about said communication device within the LAN, from said terminal device;
a device information acquiring unit operable to acquire the information about said communication device within the LAN; and
a response transmitting unit operable to transmit, in the case where said request receiving unit receives the request, from said terminal device, the information acquired by said device information acquiring unit to said terminal device as a response to the request.

27. The communication system according to claim 26,
wherein in the case where said response receiving unit does not receive the response to the request from the representative device, said determining unit is further operable to determine, as a new representative device, a communication device within the LAN other than said communication device previously determined as the representative device, based on the information stored in said intra-LAN information storing unit.

28. The communication system according to claim 26,
wherein said request transmitting unit is operable to transmit a request for individual information about processing performed by said communication device within the LAN to said representative device as the request for the information about said communication device within the LAN,
said device information acquiring unit is operable to acquire the individual information from said communication device within the LAN,
said response transmitting unit is operable to transmit the individual information acquired by said device information acquiring unit to said terminal device as a response to the request for the individual information,
said terminal device further includes a judging unit operable to judge whether the individual information received by said response receiving unit satisfies a predetermined criterion or not, and
said intra-LAN information storing unit is operable to store information indicating said communication device corresponding to the individual information judged to satisfy the predetermined criterion by said judging unit.

29. The communication system according to claim 28,
wherein the individual information indicates whether or not said communication device corresponding to the individual information has a relay function to acquire information about an other communication device within the LAN in response to a request from said terminal device and to transmit the information to said terminal device, and
in the case where the individual information indicates that said communication device has the relay function, said judging unit is operable to judge that the individual information satisfies the predetermined criterion.

30. The communication system according to claim 26,
wherein said request receiving unit is further operable to receive the request for the information about said communication device, from said the representative device, and
in the case where said request receiving unit receives the request from the representative device, said response transmitting unit is further operable to transmit the information about said communication device to the representative device as a response to the request.

31. The communication system according to claim 30,
wherein, as the request for the information about said communication device within the LAN, said request transmitting unit is operable to transmit, to said representative device, a request which is a request for a reproduction key, which includes an identifier for identifying said terminal device, the reproduction key being information necessary for reproducing a content that said communication device within the LAN have,
said communication device further includes:
a content storing unit operable to store a content;
an accepting unit operable to accept input of the identifier for identifying said terminal device; and
a reproduction key storing unit operable to store the identifier accepted by said accepting unit and the reproduction key corresponding to the content stored in said content storing unit so that the identifier and the reproduction key are associated with each other, and
in the case where the identifier stored in said reproduction key storing unit is included in the request received by said request receiving unit, said response transmitting unit is operable to transmit the reproduction key associated with the identifier to the representative device.

32. The communication system according to claim 26,
wherein said communication devices further include:
an accepting unit operable to accept input of an identifier for identifying said terminal device; and
an identifier transmitting unit operable to transmit the identifier accepted by said accepting unit, to an other communication device within the LAN, and
said device information acquiring unit is operable to acquire, from said other communication device within the LAN storing the identifier, the information about said other communication device.

33. The communication system according to claim 32,
wherein said request transmitting unit is operable to transmit, to said representative device, the request for the information which is about said communication device within the LAN and which includes the identifier for identifying said terminal device,
said communication device further includes:
an identifier receiving unit operable to receive the identifier transmitted from said representative device; and
an identifier storing unit operable to store the identifier received by said identifier receiving unit,
said request receiving unit is further operable to receive the request for the information about said communication device, from said representative device, and
in the case where said request receiving unit receives the request from said representative device and the request includes the identifier stored in said identifier storing unit, said response transmitting unit is operable to transmit the information about said communication device to said representative device.

34. The communication system according to claim 26,
wherein when said request receiving unit receives the request from said terminal device, said device information acquiring unit is operable to transfer the request to said communication device within the LAN and receive a response to the transferred request to thereby acquire the information about said communication device within the LAN.

35. The communication system according to claim 26,
wherein said communication device further include a device information storing unit operable to store the information acquired by said device information acquiring unit, and
when said request receiving unit receives the request from said terminal device, said response transmitting unit is operable to select information corresponding to the request from the information stored in said device information storing unit, and transmit the selected information to said terminal device as a response to the request.

36. The communication system according to claim 26,
wherein said request transmitting unit is operable to transmit, to said representative device, a request for a search for a communication-capable device within the LAN, as the request for the information about said communication device within the LAN,
when said request receiving unit receives the request for the search, said device information acquiring unit is operable to transmit a request for a response to said plurality of communication devices and receive the response transmitted in response to the request for the response to thereby acquire information to identify said communication device which is a transmission source of the response, and
said response transmitting unit is operable to transmit, to said terminal device, the information to identify said communication device which is obtained by said device information acquiring unit.

37. The communication system according to claim 26,
wherein said request transmitting unit is operable to transmit, to said representative device, a request for acquisition of a content list held by each of said plurality of communication devices, as the request for the information about said communication device within the LAN,
when said request receiving unit receives the request for the acquisition, said device information acquiring unit is operable to acquire the content list held by each of said plurality of communication devices from said plurality of communication devices, and
said response transmitting unit is operable to collectively transmit at least one content list acquired by said device information acquiring unit to said terminal device.

38. A terminal device connected to the Internet which communicates with a plurality of communication devices within a LAN connected to the Internet, said terminal device comprising:
an intra-LAN information storing unit operable to store information about processing performed by said plurality of communication devices;
a determining unit operable to determine one representative device which is a communication device that serves as a representative, from among said plurality of communication devices based on the information stored in said intra-LAN information storing unit;
a request transmitting unit operable to transmit a request for information about the communication device within the LAN, to said representative device determined by said determining unit; and
a response receiving unit operable to receive a response to the request from said representative device.

39. The terminal device according to claim 38,
wherein, in the case where said response receiving unit does not receive the response to the request from said representative device, said determining unit is further operable to determine, as a new representative device, a communication device within the LAN other than the communication device previously selected as said representative device, based on the information stored in said intra-LAN information storing unit.

40. The terminal device according to claim 38,
wherein said request transmitting unit is operable to transmit a request for individual information about processing performed by the communication device within the LAN to said representative device as the request for the information about the communication device within the LAN,
said terminal device further includes a judging unit operable to judge whether the individual information received by said response receiving unit satisfies a predetermined criterion or not, and
said intra-LAN information storing unit stores information indicating the communication device corresponding to the individual information judged, by said judging unit, to satisfy the predetermined criterion.

41. The terminal device according to claim 40,
wherein the individual information indicates whether or not the communication device corresponding to the individual information has a relay function to acquire information about an other communication device within the LAN in response to a request from said terminal device and to transmit the information to said terminal device, and
when the individual information indicates that the communication device has the relay function, said judging unit judges that the individual information satisfies the predetermined criterion.

42. A communication device within a LAN including a plurality of communication devices and communicates with a terminal device through the Internet connected to the LAN, said communication device comprising:
a request receiving unit operable to receive a request for the information about a communication device within the LAN, from the terminal device;
a device information acquiring unit operable to acquire the information about the communication device within the LAN from a communication device within the LAN when the request receiving unit receives the request from the terminal device; and
a response transmitting unit operable to transmit, in the case where said request receiving unit receives the request from the terminal device, the information acquired by said device information acquiring unit to the terminal device as a response to the request.

43. The communication device according to claim 42,
wherein said request receiving unit is further operable to receive the request for the information about said communication device from an other communication device within the LAN, and
in the case where said request receiving unit receives the request from the other communication device within the LAN, said response transmitting unit is further operable to transmit the information about said communication device to the other communication device within the LAN as a response to the request.

44. The communication device according to claim 42,
wherein said communication device further includes:
an accepting unit operable to accept input of an identifier for identifying the terminal device; and
an identifier transmitting unit operable to transmit the identifier accepted by said accepting unit, to the other communication device within the LAN, and
said device information acquiring unit is operable to acquire, from the other communication device within the LAN storing the identifier, the information about the other communication device.

45. The communication device according to claim 44,
wherein the request transmitted from the terminal device includes the identifier,
said communication device further includes:
an identifier receiving unit operable to receive the identifier transmitted from the other communication device within the LAN; and
an identifier storing unit operable to store the identifier received by said identifier receiving unit,
said request receiving unit is further operable to receive the request for the information about said communication device, from the other communication device within the LAN, and
in the case where said request receiving unit receives the request from the other communication device within the LAN and the request includes the identifier stored in said identifier storing unit, said response transmitting unit is operable to transmit the information about said communication device to the other communication device within the LAN.

46. The communication device according to claim 42, further comprising
a device information storing unit operable to store the information acquired by said device information acquiring unit, and
when said request receiving unit receives the request from the terminal device, said response transmitting unit is operable to select information corresponding to the request from the information stored in said device information storing unit, and transmit the selected information to the terminal device as a response to the request.

47. A communication method used in a terminal device connected to the Internet and communicates with a plurality of communication devices within a LAN connected to the Internet,
wherein the terminal device includes an intra-LAN information storing unit operable to store information about processing performed by the plurality of communication devices, and
said communication method includes:
a determining step of determining one representative device which is a communication device that serves as a representative, from among the plurality of communication devices based on the information stored in the intra-LAN information storing unit;
a request transmitting step of transmitting a request for information about the communication device within the LAN, to the representative device determined in said determining step; and
a response receiving step of receiving a response to the request from the representative device.

48. A program for a terminal device connected to the Internet and communicates with a plurality of communication devices within a LAN connected to the Internet,
wherein the terminal device includes an intra-LAN information storing unit operable to store information about processing performed by the plurality of communication devices, and
said program is for causing a computer to execute:
a determining step of determining one representative device which is a communication device that serves as a representative, from among the plurality of communication devices based on the information stored in the intra-LAN information storing unit;
a request transmitting step of transmitting a request for information about the communication device within the LAN, to the representative device determined in the determining step; and
a response receiving step of receiving a response to the request from the representative device.

49. A communication method in a communication device within a LAN including a plurality of communication devices and communicates with a terminal device through the Internet connected to the LAN, said communication method comprising:
a request receiving step of receiving a request for the information about a communication device within the LAN, from the terminal device;
a device information acquiring step of acquiring the information about the communication device within the LAN from a communication device within the LAN, when the request is received from the terminal device in said request receiving step; and
a response transmitting step of transmitting, in the case where the request is received from the terminal device in said request receiving step, the information acquired in said device information acquiring step to the terminal device as a response to the request.

50. A program for a communication device within a LAN including a plurality of communication devices and communicates with a terminal device connected to the LAN through the Internet, said program causing a computer to execute:
a request receiving step of receiving a request for the information about a communication device within the LAN, from the terminal device;
a device information acquiring step of acquiring the information about the communication device within the LAN from a communication device within the LAN, when the request is received from the terminal device in the request receiving step; and
a response transmitting step of transmitting, in the case where the request is received from the terminal device in the request receiving step, the information acquired in the device information acquiring step to the terminal device as a response to the request.
